(19) United States
(12) Patent Application Publication
(10) Pub. No.: US 2019/0293285 A1
(43) Pub. Date: Sep. 26, 2019

(54) COMPACT DUAL-FUEL COMBUSTION SYSTEM, AND FLUID HEATING SYSTEM AND PACKAGED BURNER SYSTEM INCLUDING THE SAME

(71) Applicant: Fulton Group N.A., Inc., Pulaski, NY (US)

(72) Inventors: Carl Nicholas Nett, Sandisfield, MA (US); Alireza Bahrami, Cicero, NY (US); Keith Richard Waltz, Sandy Creek, NY (US)

(21) Appl. No.: 16/439,873

(22) Filed: Jun. 13, 2019

Related U.S. Application Data
(63) Continuation-in-part of application No. 16/285,119, filed on Feb. 25, 2019.
Application No. 16/285,119 is a continuation-in-part of application No. PCT/US2019/019441, filed on Feb. 25, 2019.
(60) Provisional application No. 62/657,062, filed on Apr. 13, 2018.
(60) Provisional application No. 62/634,476, filed on Feb. 23, 2018.
(60) Provisional application No. 62/634,520, filed on Feb. 23, 2018.
(60) Provisional application No. 62/634,520, filed on Feb. 23, 2018.

(51) Int. Cl. F23L 9/04; F23C 1/00; F02D 19/08; F02M 31/16

(52) U.S. Cl. CPC F23L 9/04; F02M 31/16; F02D 19/082; F23C 1/00

(57) ABSTRACT

An inward-firing dual fuel combustion burner system comprising a burner casing configured to receive a gaseous mixture at a burner inlet and to provide hot combustion gas at a burner output; a combustion substrate disposed within the burner casing, the substrate having a shape comprising at least a semi-cone, having a substrate angle measured from a longitudinal axis, having a substrate porosity defined by a plurality of pores, and having a substrate inner surface and a substrate outer surface; the substrate configured to receive the fuel-air mixture at the outer surface of the substrate, the fuel-air mixture passing through the pores at a mixture flow rate from the substrate outer surface toward the substrate inner surface; one or a plurality of oil nozzles disposed within the combustion cavity defined by the substrate in fluidic communication with a source of pre-heated and pre-pressurized oil fuel, an oil nozzle configured to receive the oil fuel and disperse the oil fuel into the cavity; the burner configured to be operated using either a gaseous premix fuel air mixture or a pre-heated and pre-pressurized liquid fuel oil; the burner configured such that, during gaseous premix fuel operation, the fuel-air mixture ignites near the plurality of pores to form a respective plurality of flamelets, each flamelet corresponding to one of the pores; and the burner configured such that, during oil fuel operation, the oil mixture ignites during isenthalpic expansion.

### CROSS REFERENCE TO RELATED APPLICATIONS

This application claims priority to U.S. provisional patent application Ser. No. 62/657,062, filed on Apr. 13, 2018; and is a Continuation-in-part of U.S. patent application Ser. No. 16/285,119, filed Feb. 25, 2019, which claims priority to U.S. provisional patent application Ser. No. 62/634,476, filed on Feb. 23, 2018, and which claims priority to U.S. provisional patent application Ser. No. 62/634,520, filed on Feb. 23, 2018; and is a Continuation-in-part of International Application PCT/US2019/019441, filed Feb. 25, 2019, which claims priority to U.S. provisional patent application Ser. No. 62/634,520, filed on Feb. 23, 2018, the entire contents of each above are incorporated herein by reference in their entirety to the extent permitted by applicable law.

### BACKGROUND

### Field

This application relates to a compact dual fuel combustion system for the purpose of heat generation, methods of using a dual fuel combustion system, and methods of fluid heating incorporating a compact dual fuel combustion system.

### Description of the Related Art

Combustion systems are used to provide a heated thermal transfer fluid for a variety of commercial, industrial, and domestic applications such as hydronic, steam, and thermal fluid boilers, for example. Many applications benefits from the incorporation of combustion systems capable of utilizing more than one type of fuel source; for example, combustion systems that can utilize natural gas or hydrocarbon fuel oil as selectable alternatives using the same device. However, different combustion fuels may have distinctly different material properties and thermodynamic characteristics, which present significant challenges in the design of multi-fuel combustion systems. Because of the desire for improved energy efficiency, compactness, reliability, and cost reduction, there remains a need for improved multi-fuel combustion systems, as well as improved methods of manufacture thereof.

Incomplete combustion, suboptimal combustion product flow fields, and large temperature gradients can result in a decrease in overall burner system performance. This is particularly true of combustion systems incorporated into fluid heating systems for the production of hot water, steam, and thermal fluid for hot liquid or steam for ambient temperature regulation, hot water consumption, or commercial and industrial applications. Moreover, residential, commercial, industrial and government uses of combustion systems for a variety of applications benefit from improvements that decrease the size, volume and footprint of these apparatuses, particularly those that utilize premix fuel and air (oxygen) combinations. Thus there remains a need for an improved compact multi-fuel combustion system having improved thermal efficiency.

### SUMMARY

Disclosed herein is a dual-fuel combustion system utilizing an inward firing premix burner for natural gas combustion and a short-flame length fuel oil burner system utilizing preheated oil.

Also disclosed is an inward firing premix burner combustion system with a composite semi-cone combustion substrate that also defines the combustion cavity for a preheated oil burner.

Also disclosed is an inward firing premix burner combustion system with a composite semi-cone combustion substrate that also defines the combustion cavity for a preheated oil burner also comprising a guide or baffle for directing the air or fuel-air mixture.

Also disclosed is a method for isenthalpic expansion of fuel oil that can be exploited in fluid heating system combustion systems.

Also disclosed is a method for the control of thermodynamic state of liquid fuel to achieve the correct thermodynamic condition necessary to realize the benefits of isenthalpic expansion at the burner dispersion nozzle.

Also disclosed are combustion systems comprising elements of both inward-firing gas burner geometries and isenthalpic oil burner components integrated to provide dual fuel combustion systems that alleviates many of the disadvantages of gas burners and oil jet burners.

Also disclosed are methods of utilizing isenthalpic expansion of a preheated, pressurized fuel oil can produce short flame envelopes compatible with highly compact combustion systems.

Also disclosed is that isenthalpic expansion of a preheated, pressurized fuel oil are amenable to standard burner temperature control methods common to fluid heating systems.

Also disclosed are combustion volume geometries comprising dual-fuel premix gas and isenthalpic expansion of preheated, pressurized fuel oil elements that can be optimized to concurrently achieve high performance of both the premix and oil operating modes.

Also disclosed are combustion systems comprising tangential or oblique inlet ports for air or premix gas-air mixtures further comprising dual-fuel premix gas and isenthalpic expansion of preheated, pressurized fuel oil elements that can obviate the requirement for baffles to guide and direct the incoming flow stream.

Also disclosed are dual fuel combustion systems comprising dual-fuel premix gas and isenthalpic expansion of a preheated, pressurized fuel oil elements that result in reduction of produced nitrogen oxide (NOx) byproducts.

Also disclosed are dual fuel combustion systems comprising dual-fuel premix gas and isenthalpic expansion of a preheated, pressurized fuel oil elements that admit the use of different shapes for the combustion volume and still achieve compact, thermally efficient design objectives.

The above described and other features are exemplified by the following figures and detailed description.

### BRIEF DESCRIPTION OF THE DRAWINGS

Referring to the figures, which are exemplary embodiments, and wherein the like elements are numbered alike.

FIG. 1A shows an illustration of the elements used to define semi-cone geometry.

FIG. 1B shows a perspective diagram of a truncated cone in accordance with embodiments of the present disclosure.

FIG. 1C shows a perspective diagram of a semi-cone in accordance with embodiments of the present disclosure.

FIG. 1D shows a perspective diagram of a composite semi-cone in accordance with embodiments of the present disclosure.

FIG. 1E shows a perspective diagram of a composite semi-cone without cylindrical sections in accordance with embodiments of the present disclosure.

FIG. 2A shows a cross-sectional diagram of an embodiment of a jet burner combustion system in the vertical orientation using a premix gas and air mixture in accordance with embodiments of the present disclosure.

FIG. 2B shows a cross-sectional diagram of an embodiment of a jet burner combustion system in the vertical orientation using an oil fuel in accordance with embodiments of the present disclosure.

FIG. 3 shows a cutaway diagram of an embodiment of a premix combustion system with a single semi-conical combustion substrate in accordance with embodiments of the present disclosure.

FIG. 4A shows an illustration of the velocity vectors comprising the calculation of the combustion flame equilibrium ratio (ρ) in the region between a porous combustion substrate and a flamelet in accordance with embodiments of the present disclosure.

FIG. 4B shows an illustration of the velocity vectors comprising the calculation of the combustion flame equilibrium ratio (ρ) in the region between a porous combustion substrate and a flame front in accordance with embodiments of the present disclosure.

FIG. 4C shows an illustration of the symmetric pores arranged in a regular distribution in a section of a porous combustion substrate in accordance with embodiments of the present disclosure.

FIG. 4D shows an illustration of the circular pores arranged distributed in a section of a porous combustion substrate in accordance with embodiments of the present disclosure.

FIG. 4E shows an illustration of non-circular pores arranged in a regular distribution in a section of a porous combustion substrate in accordance with embodiments of the present disclosure.

FIG. 4F shows an illustration of an embodiment of a three-dimensional structure for a pore of a porous combustion substrate in accordance with embodiments of the present disclosure.

FIG. 4G shows an illustration of circular holes and slots arranged in a regular distribution in a section of a porous combustion substrate in accordance with embodiments of the present disclosure.

FIG. 4H shows a perspective drawing of the premix fuel-air flow field in the burner through the pores of a semi-cone substrate with an acute substrate angle in accordance with embodiments of the present disclosure.

FIG. 4I shows a perspective drawing of the premix fuel-air flow field in the burner through the pores of a semi-cone substrate with an acute substrate angle and proximal diameter equal to zero in accordance with embodiments of the present disclosure.

FIG. 4J shows a perspective drawing of the premix fuel-air flow field in the burner through the pores of a semi-cone substrate with an acute substrate angle and an instrument conduit between the proximal end of the substrate and the burner head in accordance with embodiments of the present disclosure.

FIG. 4K shows a perspective drawing of the premix fuel-air flow field in the burner through the pores of a semi-cone substrate with substrate angle equal to zero and an instrument conduit between the center of the substrate and the burner head in accordance with embodiments of the present disclosure.

FIG. 4L shows a perspective drawing of the premix fuel-air flow field in the burner through the pores of a semi-cone substrate with substrate angle equal to zero and an instrument package near the circumference of the substrate in accordance with embodiments of the present disclosure.

FIG. 4M shows a perspective drawing similar to FIG. 4L with instrument package located on a side in accordance with embodiments of the present disclosure.

FIG. 5A shows a plot of the bubble point temperature and pressure for a typical liquid fuel in accordance with embodiments of the present disclosure.

FIG. 5B shows a plot of liquid-vapor saturation curve as a function of enthalpy and pressure for a single species of hydrocarbon fuel component in accordance with embodiments of the present disclosure.

FIG. 5C shows a plot of bubble point as a function of enthalpy and pressure for a fuel comprising several hydrocarbon component species in accordance with embodiments of the present disclosure and thermodynamic state transition for a pressurized fluid.

FIG. 5D shows a plot of bubble point as a function of enthalpy and pressure for a fuel comprising several hydrocarbon component species in accordance with embodiments of the present disclosure and the thermodynamic state transition for a preheated, pressurized fluid.

FIG. 5E shows a functional block diagram of a dual fuel combustion system in accordance with embodiments of the present disclosure.

FIG. 5F shows a cross-sectional diagram of the flame structure of an oil burner where the injected oil stays in the liquid phase in accordance with embodiments of the present disclosure.

FIG. 5G shows a cross-sectional diagram of the flame structure of an oil burner where the injected oil experiences isenthalpic expansion in accordance with embodiments of the present disclosure.

FIG. 6A shows a cutaway diagram of an embodiment of a dual fuel combustion system with a single semi-conical premix combustion substrate in accordance with embodiments of the present disclosure.

FIG. 6B shows a cross-sectional diagram of the details near the liquid fuel injection nozzle an embodiment of a dual fuel combustion system with a single semi-conical premix combustion substrate in accordance with embodiments of the present disclosure.

FIG. 6C shows a cross-sectional diagram of an embodiment of a simplex oil nozzle in accordance with embodiments of the present disclosure.

FIG. 6D shows a cross-sectional diagram of an embodiment of a modulating nozzle in accordance with embodiments of the present disclosure.

FIG. 7 shows a cross-sectional diagram of an embodiment of a dual fuel combustion system with a single semi-conical premix combustion substrate illustrating the oil dispersion geometry in accordance with embodiments of the present disclosure.

FIG. 8A shows a plot of flame length as a function of oil dispersion angle for an embodiment of a dual fuel combustion system with a single semi-conical premix combustion substrate in accordance with embodiments of the present disclosure.

FIG. 8B shows a plot of combustion gas flow streamline deviation from perpendicular to the tube sheet and a function of substrate cone angle for an embodiment of a dual fuel combustion system with a single semi-conical premix combustion substrate in accordance with embodiments of the present disclosure.

FIG. 9 shows a cross-sectional diagram of combustion gas flow streamlines and velocity vectors for a simulation of an embodiment of a of a dual fuel combustion system with a single semi-conical premix combustion substrate utilizing fuel oil in accordance with embodiments of the present disclosure.

FIG. 10A shows a cutaway diagram of an embodiment of a dual fuel combustion system with a single semi-conical inward firing premix combustion substrate and a tangential premix fuel-air inlet in accordance with embodiments of the present disclosure.

FIG. 10B shows a top-view cross-sectional diagram of an embodiment of a dual fuel combustion system with a tangential premix fuel-air inlet in accordance with embodiments of the present disclosure.

FIG. 11 shows a cross-sectional diagram of an embodiment of a dual fuel combustion system with an annular semi-conical inward firing premix combustion substrate in accordance with embodiments of the present disclosure.

FIG. 12 shows a cutaway diagram of an embodiment of a dual fuel combustion system with an annular semi-conical inward firing premix combustion substrate in accordance with embodiments of the present disclosure.

FIG. 13 shows a cross-sectional diagram of an embodiment of a dual fuel combustion system with an annular cylindrical inward firing premix combustion substrate in accordance with embodiments of the present disclosure.

FIG. 14 shows a cutaway diagram of an embodiment of a dual fuel combustion system with an annular cylindrical inward firing premix combustion substrate in accordance with embodiments of the present disclosure.

FIG. 15 shows a cross-sectional diagram of an embodiment of a dual fuel combustion system with a cylindrical inward firing premix combustion substrate in accordance with embodiments of the present disclosure.

FIG. 16 shows a cutaway diagram of an embodiment of a dual fuel combustion system with a cylindrical inward firing premix combustion substrate in accordance with embodiments of the present disclosure

FIG. 17 shows a perspective drawing of a dual fuel combustion burner with a flat (α=90 degrees) combustion substrate with a pore pattern of slots and holes in accordance with embodiments of the present disclosure.

FIG. 18 shows a cross-sectional diagram for the dual fuel combustion systems illustrated in FIG. 17 in accordance with embodiments of the present disclosure.

FIG. 19 shows a perspective diagram of an embodiment comprising elements configured for dual-fuel premix gas and isenthalpic expansion of a preheated, pressurized fuel oil in accordance with embodiments of the present disclosure.

FIG. 20 shows a cross-sectional diagram that further illustrates the oil pathway shown in FIG. 19 in accordance with embodiments of the present disclosure.

FIG. 21 which shows a perspective diagram of an embodiment comprising elements configured for dual-fuel premix gas and isenthalpic expansion of a preheated, pressurized fuel oil in accordance with embodiments of the present disclosure.

FIG. 22 shows a perspective diagram of an embodiment using transverse flow and an array comprising a plurality of nozzles together with a plate (semicone angle α=90 degrees) combustion substrate in accordance with embodiments of the present disclosure.

FIG. 23 shows a perspective diagram of an embodiment comprising elements configured for dual-fuel premix gas and isenthalpic expansion of a preheated, pressurized fuel oil in accordance with embodiments of the present disclosure.

FIG. 24 shows a cross-sectional diagram that further illustrates the oil pathway shown in FIG. 23 in accordance with embodiments of the present disclosure.

### DETAILED DESCRIPTION

In U.S. Provisional Application No. 62/634,476 and International Application (PCT) PCT/US19/19460, the inventors disclosed improvements to premix burner combustion systems comprising inward-firing geometries, including the use of composite semi-cone burner combustion substrates and flow guides or baffles. The applicants also discovered that outward firing combustion systems can suffer incomplete combustion due to the small and constrained combustion volume available, large temperature gradients that can result in material and performance failures, and undesirable flow characteristics of the hot combustion gases and products can be produced in the apparatus.

In the U.S. Provisional Application No. 62/634,520 the inventors further discovered that premix fuel-air burner combustion systems with composite semi-cone substrates that further comprises a metal fiber mesh layer on the inner surface of the substrate improves the performance and reliability of embodiments, particularly when operated in the surface combustion regime, as described herein.

As further discussed herein, the Applicants have further surprisingly discovered that compact dual-fuel type combustion systems may be achieved based on integrating inward-firing gas burner elements and isenthalpic expansion-enabled (alternatively, “flashed”) preheated and pre-pressurized oil burner components.

Disclosed is an improved compact dual fuel combustion system for applications that require heat generation that provides improved efficiency, apparatus lifecycle and performance while still supporting dual fuel operation.

While not wanting to be bound by theory, the following nomenclature is useful in the detailed description that follows:

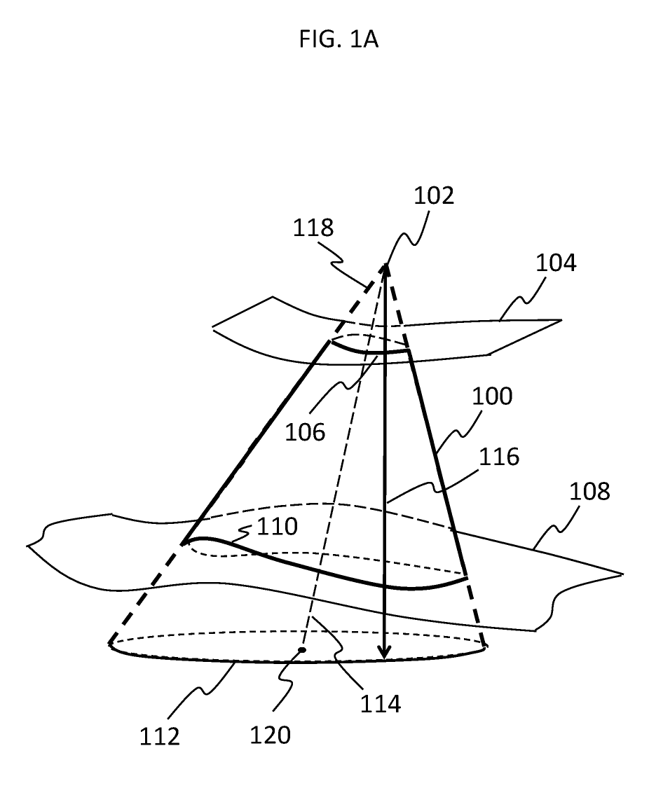

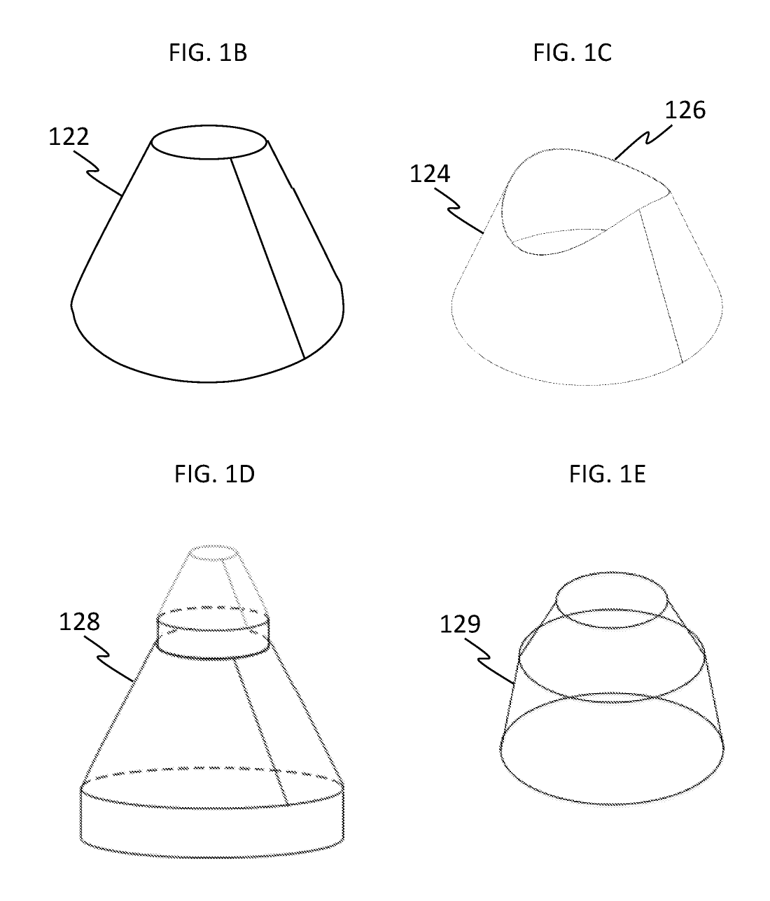

Consistent with convention, a cone is a geometric surface that can be used to describe certain features of embodiments. FIG. 1 illustrates key concepts. A cone 118 is a surface defined by a ray called the generator 116 emanating from a fixed point called the vertex 102 which intersects a fixed plane curve called the directrix 112. The directrix, as a geometric curve, need not be either continuous or convex but, when it is, it defines an interior to the cone (normal vector oriented toward the volume containing the intersection with the axis) and an exterior. The axis 114 of the cone is the straight line passing between the vertex 102 and center 120 of the plane curve defined by the directrix 114. If the axis is perpendicular to the plane of the directrix, it is a right cone; otherwise, it is an oblique cone. If the directrix is a circle, the cone is a circular cone. If the axis is perpendicular to the directrix plane for a circular cone, the cone is a right-circular cone. A semi-cone 100 is a section of a cone surface bounded between by intersecting a cone with at most two 2-dimensional surfaces. In FIG. 1, the illustrated cone is intersected by a surface 104 proximal to the vertex 102, forming an upper or proximal semi-cone edge 106. The surface 104 need not be planar or perpendicular to the axis 114 or any generator 116, and the proximal edge 106 need not be a plane curve. The illustrated cone in FIG. 1 is also intersected by a surface 108 distal from the vertex 102, forming a lower or distal edge 110. The surface 108 need not be planar or perpendicular to the axis 114 or any generator 116, and the distal edge 110 need not be a plane curve. The resulting semi-cone 100 is the surface of the cone 118 bounded above by the proximal edge 106 and by the distal edge 110 below. In the degenerate case, the proximal surface 104 intersects the cone 118 only at the vertex 102, wherein the semi-cone 100 is the surface of the cone 118 between the vertex 102 and the distal edge 110. FIG. 1C show a perspective diagram of a semi-cone 124 with a non-planar proximal edge 126. A semi-cone wherein the cone 118 is intersected by proximal 104 and distal planar surfaces 108 is a truncated cone. A semi-cone wherein the cone 118 is intersected by parallel proximal 104 and distal planar surfaces 108 is a frustum. A semi-cone wherein the cone 118 is a right circular cone, the proximal 104 and distal surfaces 108 are planar and perpendicular to the axis 114 is a right frustum. FIG. 1B shows a perspective diagram of a right frustum 122. A composite semi-cone is a composition of one or a plurality of semi-cones and zero, one or a plurality of cylinders disposed along their edges. FIG. 1D shows a perspective diagram of a composite semi-cone 128. FIG. 1E shows a perspective diagram of a composite semi-cone 129 without a cylindrical section.

For a semi-cone, the generator angle (alpha or a, as discussed further herein, e.g., regarding an angle of a combustion surface or substrate as described herein) is the angle 114 formed between a specific generator ray 116 and the axis 114 at the vertex 102. For a right circular semi-cone, right circular truncated cone or right circular frustum, all the generator angles are equal and a unique generator angle can be determined.

A semi-cone with a generator angle of ninety degrees (90°) is a flat plate, surface, disk or annulus and the limit of a family of semi-cone that share a common distal end dimensions and shape.

A burner is a combustion system designed to provide thermal energy through a combustion process to apparatuses used for a variety of applications. The burner may include, depending upon the fuel, combustion geometry and target application, a burner head that supports the combustion process, one or a plurality of nozzles or orifices, air blower with damper, burner control system, shut-off devices, fuel regulator, fuel filters, fuel pressure switches, air pressure switches, flame detector, ignition devices, air damper and fuel valves and fittings. Typical burner systems range in capacity from 30 kW to 1,500 kW (approximately 40 HP to 2,100 HP) and can be adapted to a wide range of uses including incinerators, boilers, drying systems, industrial ovens and furnaces.

A package burner is a burner combustion system designed to be incorporated as a standalone modular subsystem unit into apparatuses used for a variety of applications. The package burner may include, depending upon the fuel, combustion geometry and target application, an integrated subsystem comprising a burner head that supports the combustion process, one or a plurality of nozzles or orifices, air blower with damper, burner control system, shut-off devices, fuel regulator, fuel filters, fuel pressure switches, air pressure switches, flame detector, ignition devices, air damper and fuel valves and fittings. Typical package burner systems range in capacity from 30 kW to 1,500 kW (approximately 40 HP to 2,100 HP) and can be adapted to a wide range of uses including incinerators, boilers, drying systems, industrial ovens & furnaces.

In the discussion that follows, we distinguish three types of physical combustion mechanisms. First, “volume combustion” occurs where a fuel-air mixture is ignited in a spatial volume. A physical structure may contain the combustion process, such as in a cavity burner, but the details of the structure do not directly participate in the thermodynamic combustion process. Second, for “surface combustion”, the combustion process (or a majority thereof) occurs directly upon—or very near, or largely in contact with—a burner combustion surface. In some cases, some form of physical insulating or separation layer may be needed at the burner surface to ensure the burner surface does not get too hot or to provide otherwise needed separation from the surface. The physical, geometrical and material characteristics of the surface contribute to determining the thermodynamic physics. Third, in “suspended flame combustion” (SF combustion), the combustion process (or a majority thereof) occurs near—but not directly on—the surface of a combustion substrate, which provides physical support for the generation of the flame front. In some conditions, a small portion of the flame may contact the burner surface (as described more hereinafter). In SF combustion, the flame front (or a majority thereof) is suspended near a positional equilibrium at a distance from the substrate determined partly by a balance of opposing forces due to fuel-air mass flow and flame migration toward its fuel source. If the fuel-air mass flow is reduced below a threshold, the flame front can approach the substrate and enter a regime of surface combustion. If the fuel-air mass flow is increased above a threshold, the flame front can enter a regime of volume combustion. A boiler is a fluid heating system incorporating a heat exchanger that may be used to exchange heat between any suitable fluids, e.g., a first fluid and the second fluid, wherein the first and second fluids may each independently be a gas or a liquid. In the disclosed system, the first fluid, which is directed through the heat exchanger core, is a thermal transfer fluid, and may be a combustion gas, e.g., a gas produced by fuel fired combustor, and may comprise water, carbon monoxide, nitrogen, oxygen, carbon dioxide, combustion byproducts or combination thereof. The thermal transfer fluid may be a product of combustion from a hydrocarbon fuel such as natural gas, propane, or diesel, for example.

Also, the second fluid, which is directed through the pressure vessel and contacts an entire outer surface of the heat exchanger core, is a production fluid and may comprise water, steam, oil, a thermal fluid (e.g., a thermal oil), or combination thereof. The thermal fluid may comprise water, a C2 to C30 glycol such as ethylene glycol, a unsubstituted or substituted C1 to C30 hydrocarbon such as mineral oil or a halogenated C1 to C30 hydrocarbon wherein the halogenated hydrocarbon may optionally be further substituted, a molten salt such as a molten salt comprising potassium nitrate, sodium nitrate, lithium nitrate, or a combination thereof, a silicone, or a combination thereof. Representative halogenated hydrocarbons include 1,1,1,2-tetrafluoroethane, pentafluoroethane, difluoroethane, 1,3,3,3-tetrafluoropropene, and 2,3,3,3-tetrafluoropropene, e.g., chlorofluorocarbons (CFCs) such as a halogenated fluorocarbon (HFC), a halogenated chlorofluorocarbon (HCFC), a perfluorocarbon (PFC), or a combination thereof. The hydrocarbon may be a substituted or unsubstituted aliphatic hydrocarbon, a substituted or unsubstituted alicyclic hydrocarbon, or a combination thereof. Commercially available examples include Therminol® VP-1, (Solutia Inc.), Diphyl® DT (Bayer A. G.), Dowtherm® A (Dow Chemical) and Therm® S300 (Nippon Steel). The thermal fluid can be formulated from an alkaline organic compound, an inorganic compound, or a combination thereof. Also, the thermal fluid may be used in a diluted form, for example with a concentration ranging from 3 weight percent to 60 weight percent, wherein the concentration is determined based on a weight percent of the non-water contents of the thermal transfer fluid in a total content of the thermal transfer fluid.

An embodiment in which the thermal transfer fluid comprises predominately gaseous products from combustion of natural gas or propane, and further comprises liquid water, steam, or a combination thereof and the production fluid comprises liquid water, steam, a thermal fluid, or a combination thereof is specifically mentioned.

A gaseous fuel burner is a type of (non-premix) burner combustion system wherein fuel is ejected from one or a plurality of orifices or nozzles, and the partially oxygenated fuel is ignited to produce a flame. An oil fuel burner is a type of burner combustion system wherein oil fuel is ejected from one or a plurality of orifices or nozzles, and the partially oxygenated fuel is ignited to produce a flame. A dual fuel burner is a type of burner combustion system wherein either gaseous fuel or oil fuel may be used as the fuel source, only one type in operation at a time.

A jet burner is a type of burner combustion system wherein fuel is ejected from one or a plurality of orifices or nozzles, and the lean or partially oxygenated fuel is ignited to produce a flame.

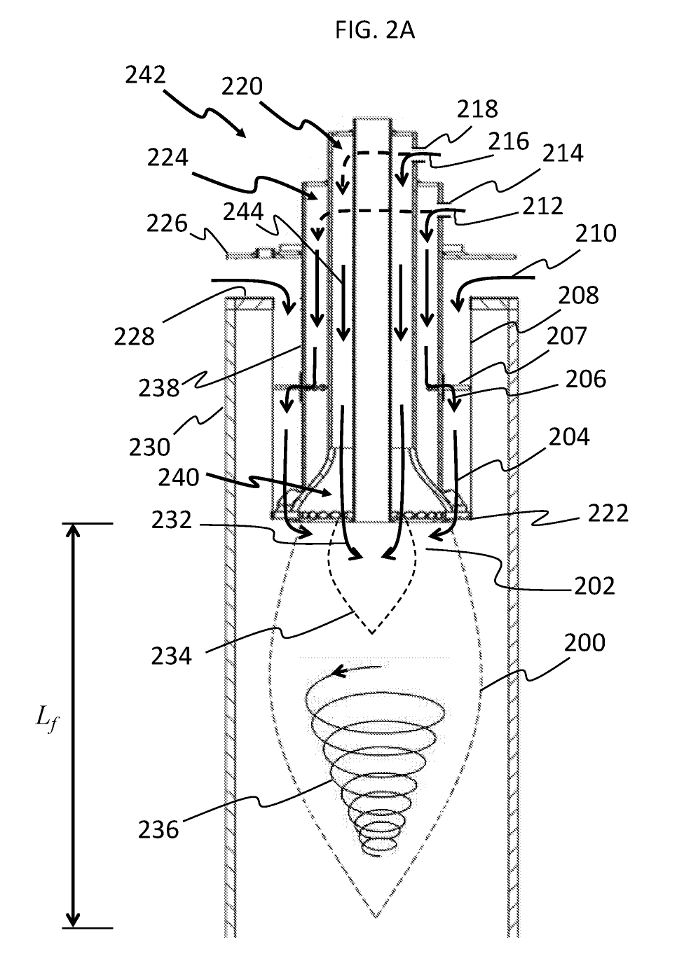

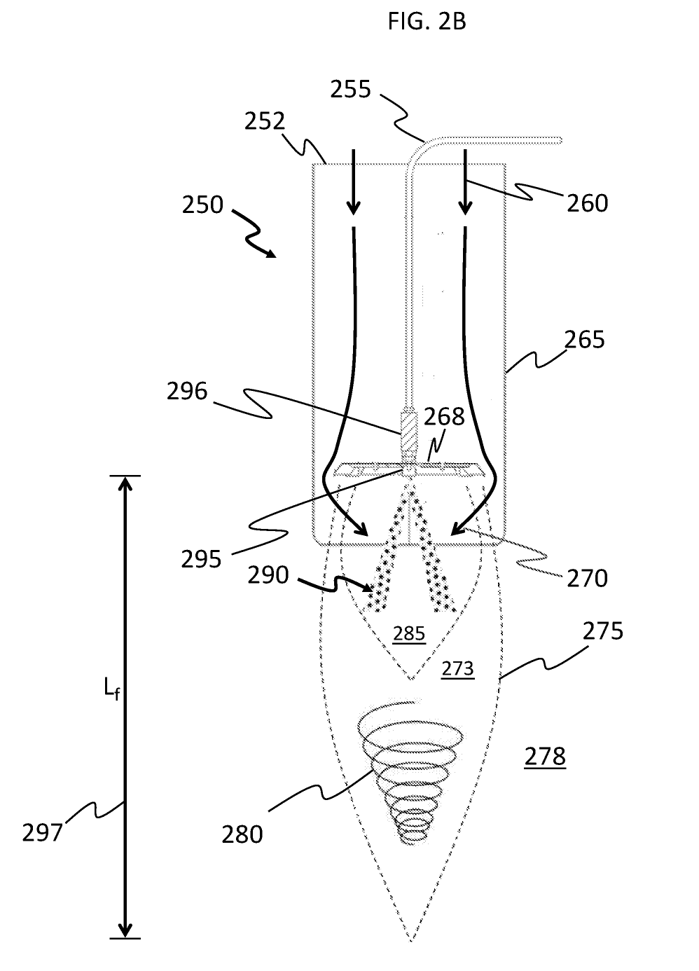

Disclosed in FIG. 2A is an embodiment of a jet burner combustion system 242 operating using gaseous (e.g., propane, natural gas) fuel. Fuel in a primarily vapor state 216 enters an inner annular channel 220 through a conduit 218 and flows 244 under pressure through openings in the burner head 222 into the region 232 of the primary reaction zone 234. Air 210 flows through an opening 226 in the top head 228 under pressure provided by a fan (not shown). The air flows 204 in the space between the inner wall of the blast tube 208 and the outer wall of the burner 238 and through orifices in the burner head 222 into the region supporting the jet flame 200. In this embodiment, a second vapor fuel stream 212 flows through a conduit 214 into an outer annular channel 224. The second fuel stream 206 passes through a series of injectors 207 to be aerated by mixing with the air flow 204, providing a leaner mixture to feed the secondary reaction zone 202 of the flame 200. The rich fuel stream flows into a manifold 240 that provides an increase in flow velocity as the fuel stream passes through openings in the burner head 222. Note that neither the rich primary fuel stream 216 nor the lean aerated secondary fuel stream 212 contain fuel-oxygen mixtures capable of auto-ignition at the temperature and pressure present in inner 220 and outer 224 fuel channels.

The long flame length characteristic of a jet burner flame can be mitigated by using a porous substrate to support the flame, breaking the single long flame structure into many small flames concentrated in a compact region in certain specialized embodiments such as an outward-firing premix (air and fuel are mixed upstream of the combustion region and delivered to the burner apparatus) burner.

The flame 200 produced by the ignited fuel jet stream is a rotating structure 236 and can extend in length L_{f} a significant distance in the furnace 230 cavity. An example of a jet burner combustion system is the Fulton 40-60 Horsepower LONOX® Burner where the flame may be two-to-four feet (0.6 to 1.2 meters) in length and occupy over half the length of the furnace 230.

Moreover, the jet burner embodiment of FIG. 2A exhibits other undesirable characteristics. First, the velocity of the fuel vapor streaming through orifices in the burner head contributes importantly to the separation distance between the burner head 222 and the flame 200 front. As the vapor velocity decreases, the distances between the flame front and burner head likewise decreases. Extended operation of the burner at a low turndown (ratio between burner maximum power output and low-power operating point)—equivalently, small separation distance between the burner head and flame front—can cause material failures of the components, short mean-time-between-failure (MTBF), and reduced burner lifecycle.

Second, to achieve the higher pressure required at the burner head, both the air stream 210 and the lean 212 and rich 216 fuel flows must be maintained at relatively high pressures. That is, a significant fraction of the fan power used to drive these flows must be expended to overcome the pressure drops from the air 226, lean fuel 214 and rich fuel 218 conduits to the burner head 222 and maintain a relative high flow velocity.

Third, the mixing of the lean fuel 214 and rich fuel 218 flow streams with the air flow 204 is primarily generated by the flow of the fuels through small orifices in the burner head 222. Low turndown ratios consequently imply a reduction in fuel-air mixing, which can increase the production of incomplete combustion byproducts and undesirable emissions (e.g., NOx). Hence, the requirement for higher air and fuel flow velocities imposes limitations on low power operation, durability, lifecycle, maintenance requirements and emission characteristics.

Disclosed in FIG. 2B is an embodiment of an oil jet burner combustion system 200 operating using liquid oil as the fuel source. Liquid fuel is conveyed from a storage location (not shown) through a fuel conduit 255 to a nozzle adapter 296 and into a dispersion nozzle 295. The nozzle 295 atomizes the oil stream into a spray 290 with prescribed dispersion geometry into the combustion region 278.

Simultaneously, air is directed from an outside 260 through an air inlet 252 and into a blast tube 265. The air stream, under pressure, passes around and through a spinner 268 designed to create a vertical flow structure 280 that promotes downstream mixing of the air stream and the atomized oil spray. The air stream is directed 270 out of the blast tube into the combustion region 278. The atomized liquid oil spray 290 and the incoming airstream from the blast tube 265 mix in a relatively cool preheating zone 285 within the flame envelope 275. Once the liquid fuel vaporizes on the surface of the oil droplets sufficiently in the presence of oxygen from the blast tube, the mixture ignites in the combustion zone 273 to release heat energy.

A key disadvantage of the oil jet burner embodiment of FIG. 2B is the long flame length 297 exhibited by these combustion systems. The oil droplets emanating from the dispersion nozzle 295 to form the atomized oil spray 290 have momentum derived from the force of the liquid oil driven under pressure through the oil conduit 255. This particle momentum carries the droplets downstream of the nozzle 295, elongating the preheating zone where the oil undergoes the phase transition and mixing necessary to form a combustible combination of vapor and oxygen in the combustion zone 273. These processes determine a substantial fraction of the overall flame structure length, which in typical commercial fluid heating (e.g., boiler) applications may be two to over four feet in length. Thus, the underlying thermodynamic, chemical and stoichiometric processes impose critical constraints on attempts to design compact, short-flame-length combustion systems.

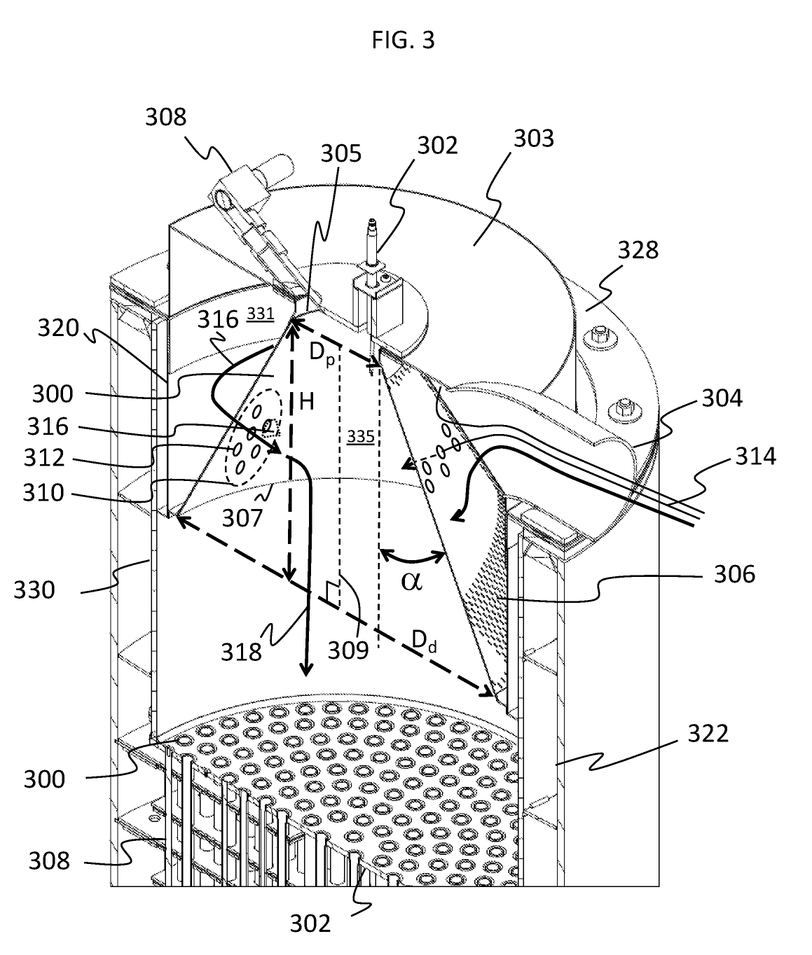

The inventors have unexpectedly discovered that for premix gaseous fuel combustion systems, an inward-firing burner geometry alleviates many of the disadvantages inherent in established designs. (“Inward” firing denotes the general case where flow of air and/or gaseous fuel and/or a mixture thereof occurs, or is directed, from a region bounded by or near an inner wall of the burner or furnace inward, or generally towards, the burner centerline where combustion occurs. In structures related to families of semicone geometries, like flat semicones with semicone angle α=90 degrees, any ambiguity is resolved by considering the application of the definition of “inward” direction applied to the corresponding family of semicones.) FIG. 3 shows a cutaway diagram of an embodiment of an inward-firing premix burner comprising a semi-cone combustion substrate, although some advantages of inward-fining premix burner embodiments discovered by the inventors are not limited to the composite semi-cone geometry. A semi-cone shaped combustion substrate 300 is disposed between the burner top head 303 and the inner surface of the furnace 330. In this embodiment, the burner combustion substrate is a right circular frustum wherein the proximal edge 305 is a planar circle perpendicular to the axis 309 with diameter Dₚ and distal edge 307 a planar circle perpendicular to the axis 309 with diameter D_{d}, with height H. The burner combustion substrate angle, α, in a right frustum embodiment is then determined to be:

α=arctan[(D_{d},Dₚ)/H] Eq. 1

Dimensions of the combustion substrate depend upon the burner power, capacity, performance and size requirements of a specific application. Proximal diameters (Dₚ) between 1 inch and 59 inches is specifically mentioned. Distal diameters (Dd) between 2 inches and 60 inches is specifically mentioned. Substrate height (H) between 1 inch and 60 inches is specifically mentioned.

The semi-cone sections of the burner combustion substrate angle may have any suitable generator angle between 1 degree, 2 degrees, 3 degrees, 4 degrees, 5 degrees, 10 degrees to 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees, 50 degrees, 60 degrees, 70 degrees, 80 degrees, 85 degrees, and 90 degrees wherein the foregoing upper and lower bounds can be independently combined. For the right circular semi-cone, right circular truncated cone, and the right circular frustum, the burner combustion substrate angles between 18 degrees and 35 degrees is specifically mentioned. For the right circular semi-cone, right circular truncated cone, and the right circular frustum, the burner combustion substrate angle of 25 degrees is also specifically mentioned.

In some embodiments, a burner combustion substrate angle α may be 90 degrees which corresponds to a flat structure, surface, plate, disk or annulus, which may be viewed as a degenerate semi-cone that is the limit of a family of semi-cones with circumference diameter, D_{d}. For the right circular semi-cone, right circular truncated cone, and the right circular frustum, the burner combustion substrate angle α=90 degrees is specifically mentioned.

The burner combustion substrate is porous to the flow of premix fuel-air mixtures predominately in a vapor state. Substrate pores 306 are distributed over the area of the burner combustion substrate to support a flame front near the interior surface. (The pore 312 size in a local area 310 are exaggerated in the diagram for clarity and are not meant to be to scale.) The combustion process may be monitored by a sensor 308 which can detect if the flame is extinguished.

In the embodiment shown a premix(ed) fuel-air mixture 314 enters the inlet 304 of the burner and flows around and through the burner combustion substrate inward toward the axis 309. The fuel-air mixture ratio is arranged so that the premix fuel is ignited near the interior surface to form a flame structure suspended over the interior surface of the burner combustion substrate, within a burner combustion cavity 335. The flame structure may comprise individual flamelets—relatively small, distinct and stable laminar regions of combustion—which may merge at higher combustion production conditions to form a flame front suspended on or over the substrate as described below.

In a boiler application comprising a shell and tube heat exchanger, the combustion products (e.g., hot gases, particulate byproducts) flow 318 towards the tubesheet 302 where they pass through the openings 300 of the heat exchanger tubes 308. Heat generated by the combustion process is transferred across the walls of the heat exchanger tubes 308 to production fluid occupying the space between the outer surfaces of the furnace 330 and heat exchanger tubes 308 and the inner surface of the pressure vessel 322, sealed at one end by the boiler top head 328.

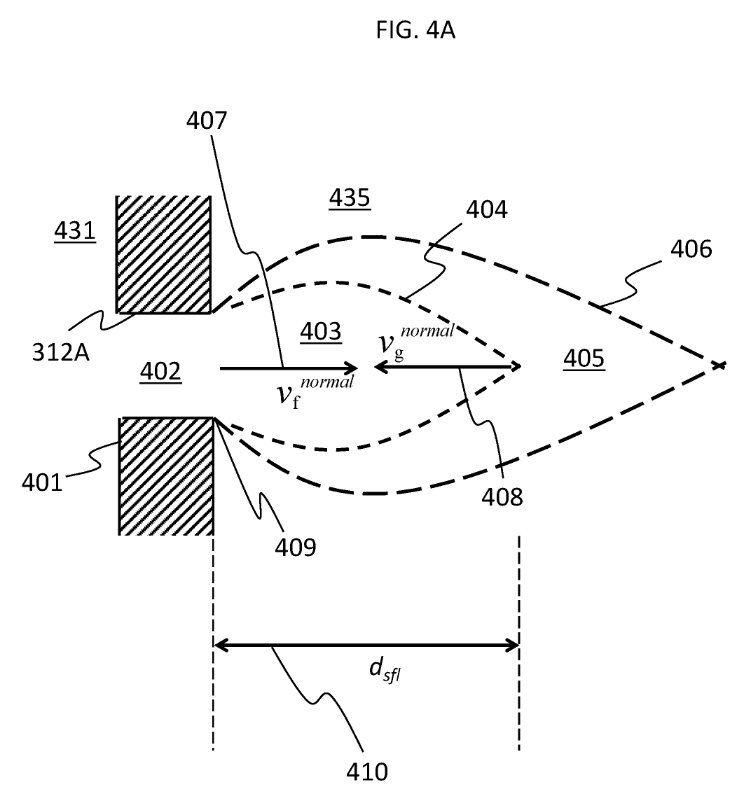

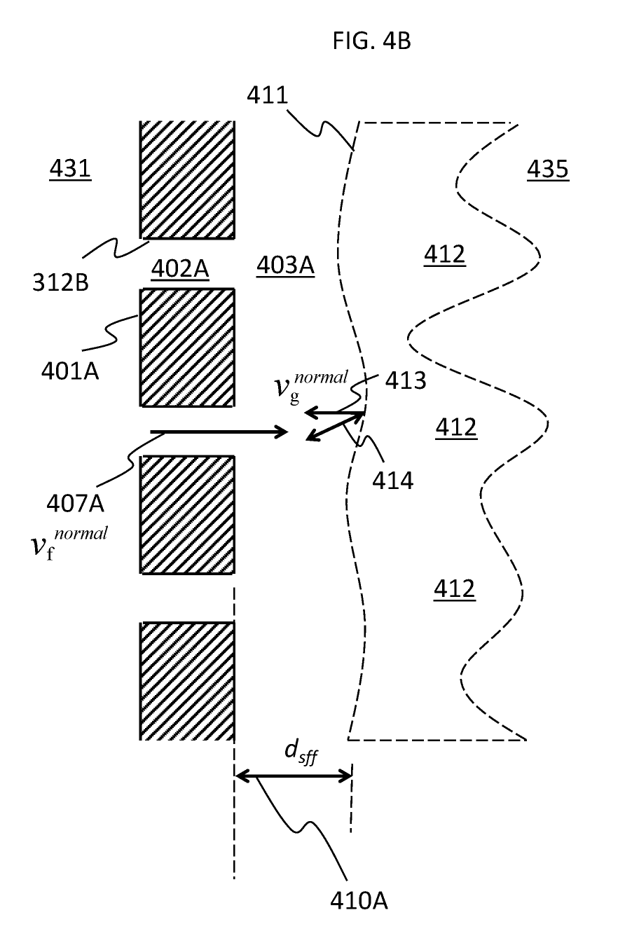

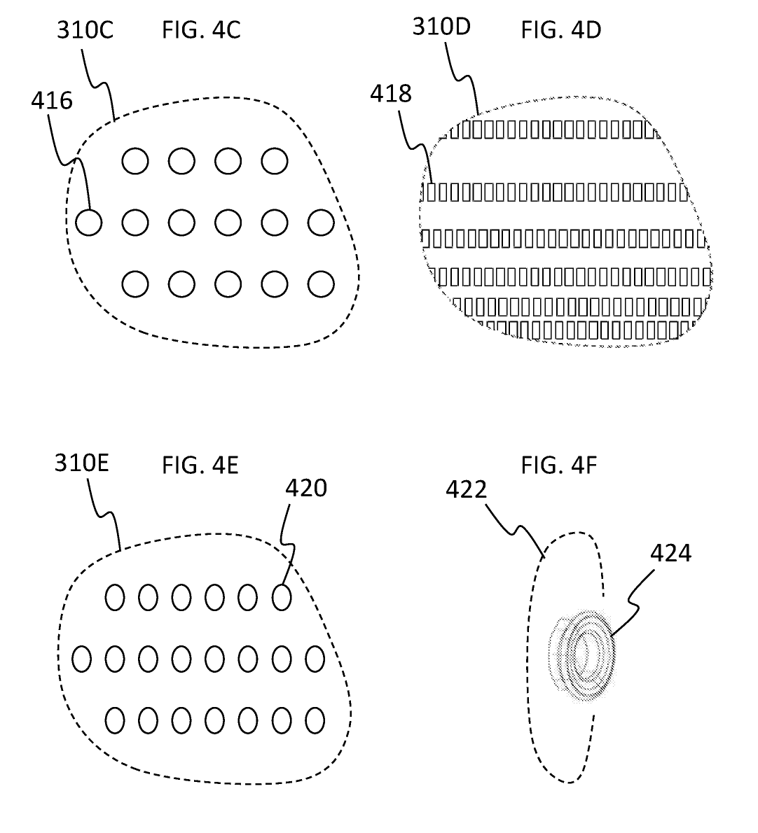

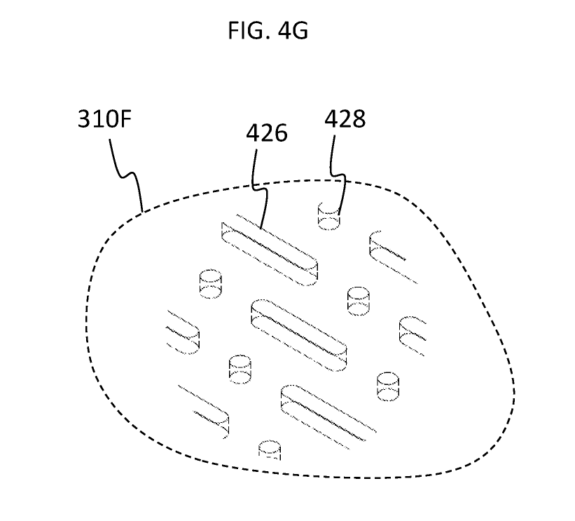

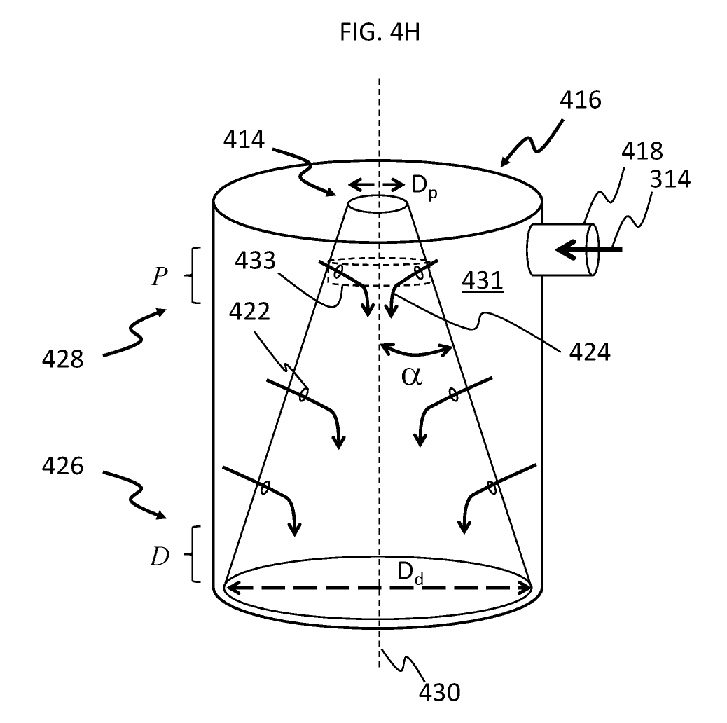

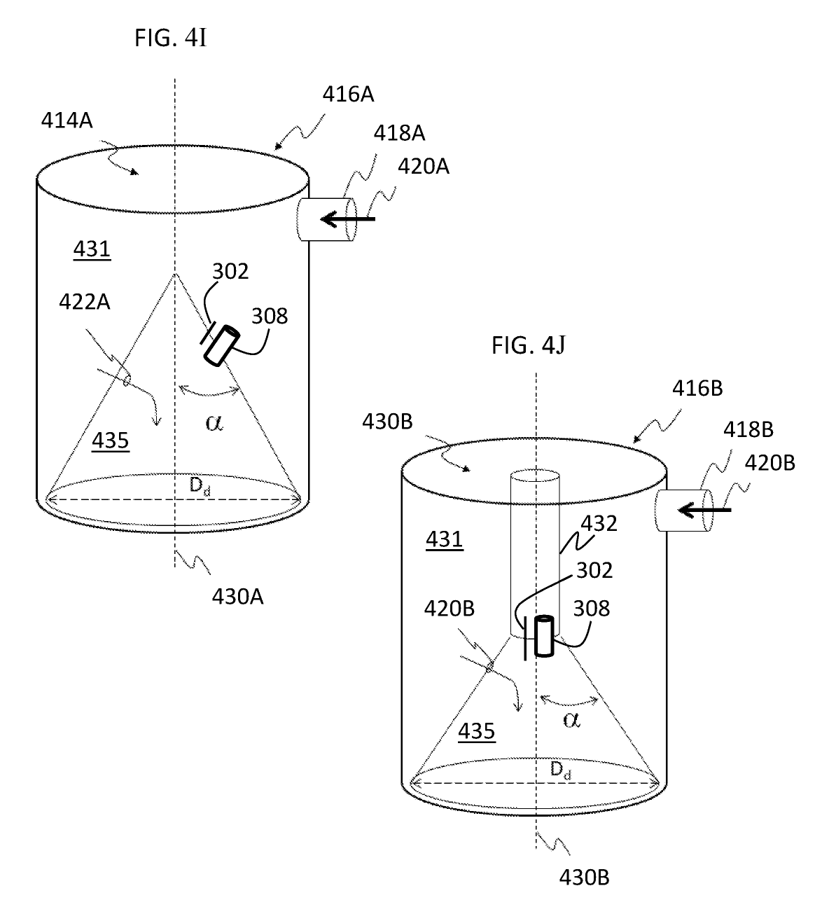

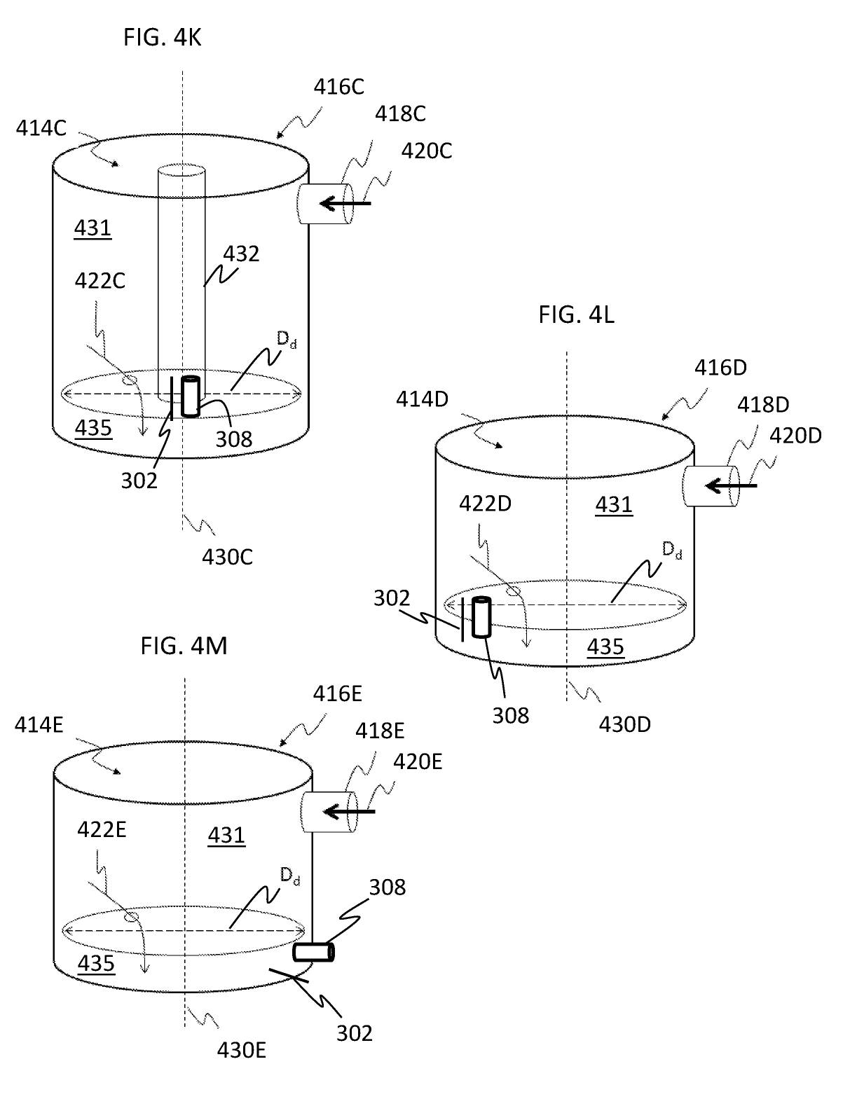

Without being bound by theory, the burner combustion substrate provides a physical structure to support the flame front generated when the premix fuel-air mixture is ignited, and the porosity of the substrate determines certain features of the resulting combustion process as illustrated in FIG. 4A which shows a region around a single pore 312A bounded by a cross-section view of the porous substrate 401. The premix fuel-air mixture is directed from an outside through the pore space bounded by the pore 312A perforation walls to an inside of the burner substrate above the pore opening called the preheating zone 403. Note that in normal operation the premix fuel-air mixture is below the autoignition temperature of the fuel premix in the interior of the pore 402 and the preheating zone 403. As the premix fuel-air mixture is carried by the flow momentum with velocity v_{f}^{normal} 407 towards the interior of the burner, the temperature rises until it exceeds the autoignition temperature of the premix fuel-air mixture and it ignites in the reaction zone 405. During stable combustion the preheating zone 403 and the reaction zone share a combustion interface 404 that forms a persistent coherent structure. (Persistent and coherent in the sense that the preheating zone 403, reaction zone 405 and the combustion interface—while not fixed structures—are also not transient structures, but persistent, recognizable and stable in a relatively long time-average sense with orderly components that exhibit stochastically stable properties.) The premix fuel-air mixture combustion primarily occurs in the reaction zone bounded releasing heat, gaseous and particulate byproducts into the burner.

The tendency for the reaction zone to consume the premix fuel-air mixture creates a force toward the pore that tends to move the combustion interface 404 near its apex over the pore with a velocity v_{g}^{normal} 408. Thus, these two opposing forces balance at a condition where the flame equilibrium ratio number:

$$1 < ρ = \frac{\vert {v}_{f}^{normal} \vert}{\vert {v}_{g}^{normal} \vert} \begin{matrix}< \\ \approx \end{matrix} 100 \qquad Eq . 2$$

in a time-average sense, where the right inequality means “less than approximately”, denoting the fact that the upper bound has been empirically determined by practical examples and should not be construed to limit or constrain the interpretation of the claims. Other embodiments may possess practical upper bounds that are higher or lower when designed by those skilled in the art. That is, an important design characteristic is to select burner substrate construction, porosity and operation conditions that ensures the flame reaction zone remains approximately stationary relative to the pore opening suspended at a distance from the pore.

For certain combinations of pore geometry, premix flow rate and operating conditions, the preheating zone 403, combustion interface 604 and reaction zone 405 remain attached 409 to edges of the pore 312A, forming a stable, persistent structure called a flamelet anchored to the interior surface of the burner substrate 401. Because the flamelet's preheating zone 403 contains uncombusted fuel-air mixture, it is relatively cool compares to the reaction zone 405. That is, the preheating zone 403 serves to insulate the substrate from the high temperature of the reaction zone 405. This is a desirable condition since it allows for high burner heat production capacity while simultaneously maintaining cooler temperatures at the burner substrate surface that promotes longevity of the substrate and reduces the likelihood of material failure. The separation of the reaction zone 405 from the substrate 401 inner surface that promotes this insulative effect can be expressed—in a local sense—as the flamelet separation distance, d_{SFL}, 410 from the inner surface of the substrate 401 over the pore 312A and the apex of the combustion interface 404. In practice, flamelet separation distances for premixtures of natural gas and air are between zero (0) inches (surface combustion) and approximately 1.75 inches (suspended flame combustion, SF), although the distance will vary (stochastically and as an average distance observed over relatively long time periods) in practice. In some embodiments, the flamelets may overlap depending on the distance between pores, flow rate, and other conditions.

Under certain operating conditions, which may be referred to herein as the “suspended flame front” state, particularly when the premix fuel-air mixture flow velocity is high, the flamelets may detach from the inner surface of the burner substrate, as illustrated in the embodiment shown in FIG. 4B. Under such conditions, the flamelets may coalesce into a new coherent combustion characterized by a flame front 411 suspended over a collection of pores 312B. The flame front formed by separating a layer of uncombusted premix fuel-air mixture 403A flowing through the interior pore space 402A of the pore 312B into a preheating zone beneath a coalesced reaction zone 412 undergoing primarily volume combustion typical of a cavity burner. Under narrow operating conditions, this coherent structure may maintain a relatively fixed position suspended over a collection of pores, separated by a suspension distance, d_{SFF}, 410A from the inner surface of the burner substrate 401A when a balance of forces exists between the premix fuel-air mixture with velocity velocity v_{f}^{normal} 407A and the opposing force of the flame front's 411 motion towards the inner surface of the burner substrate 401A with opposing velocity v_{g}^{normal} 413. Note that because the flame front is typically not anchored to the surface of the substrate, the velocity of the flame front may have a non-normal component 414 which may tend to shift the position of the reaction zone in time and space. The suspended flame front state is typically a transient or unstable state, and thus is not typically operated in for sustained operation.

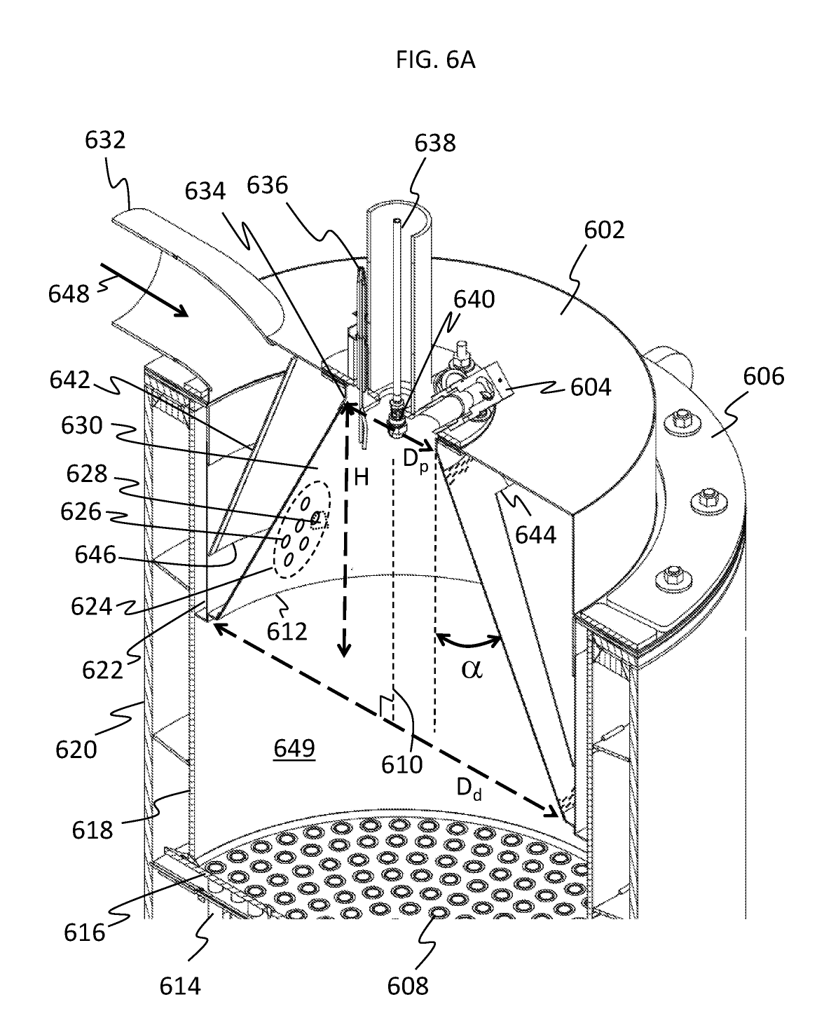

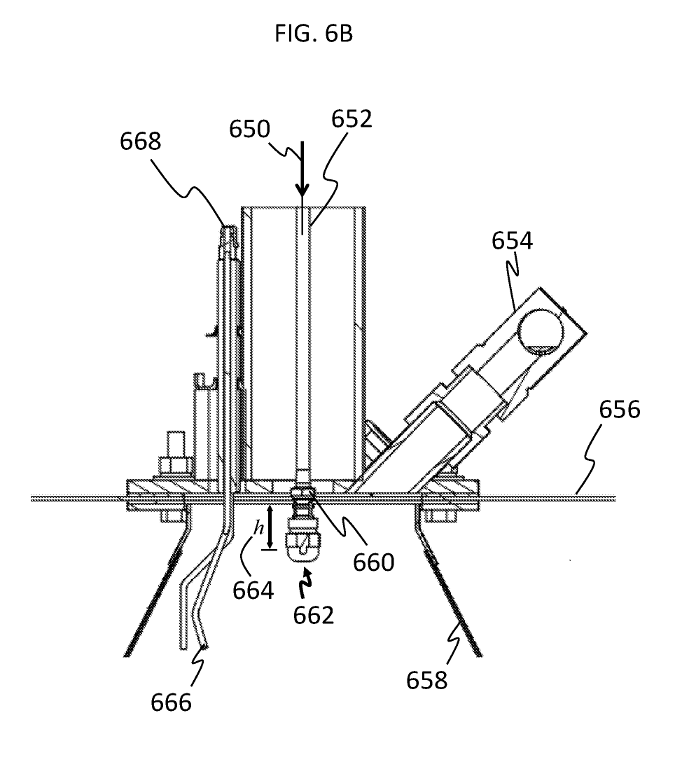

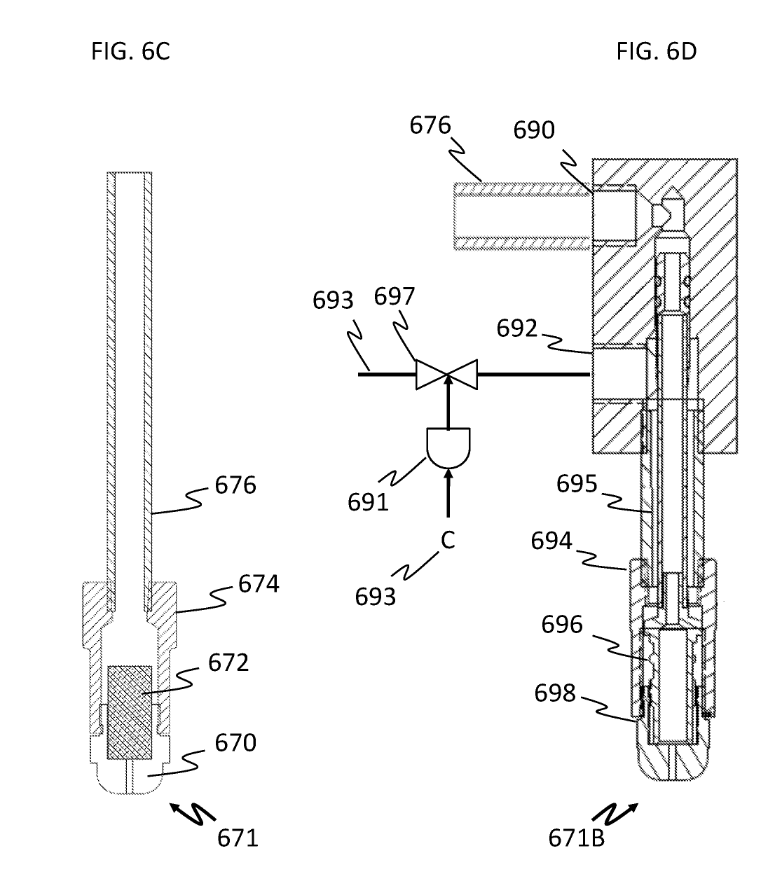

The conditions or states described herein with FIGS. 6A and 6B may be referred to collectively herein as the “suspended flame combustion” or SF combustion, as described hereinbefore.

These principles have been verified using an experimental test apparatus. Based on experimental data, Table 1 shows typical geometry and operating conditions that will exhibit suspended flame (SF) combustion in a burner using a semi-cone substrate geometry.

TABLE 1

| Parameter | Description and Values | |
|---|---|---|
| Plate Material | 439 Stainless Steel | |
| Plate Thickness | 20 GA, 0.9525 mm | |
| Port Type & Dimensions | Slots 1 mm × 6 mm dimensions. | |
| | Port Area = 5.79 mm² | |
| Number of Slots | 1,834 | |
| Flow Mean Velocity | 1.2 m/s to 27 m/s tested | |
| Flow Port Loading | 3.69 W/mn²to 82.93 W/mm² | |
| Burner Input | 879765.4 | W |
| Cone Area | 84,424.2 | mm² |
| Dₚ | 354 | mm |
| D_{d} | 472 | mm |
| Height | 25.4 | mm |

Porosity of the burner combustion substrate can be achieved by a number of constructive means, so long as they equivalently achieve and maintain the semi-conical shape and porosity characteristics required by a specific set of design parameters. Perforations in a solid substrate, including perforations in a metal sheet, are specifically mentioned.

The pore 2-dimensional and 3-dimensional structure, together with the distribution of pores in the burner combustion substrate, are designed in concert to achieve an operational flame structure required to meet the specifications a particular application. FIG. 4C shows a uniform distribution of circular perforations 416 in a local region 310C of a solid continuous burner combustion substrate. The pores 418 may be non-circular, as shown in FIG. 4D, and non-uniformly distributed on the burner combustion substrate. The porosity may result from perforations in a continuous surface; other equivalent embodiments are possible and known to those skilled in the art. FIG. 4E shows a local region 310E of porous substrate wherein the pore 420 shape is unsymmetrical. Finally, some or all of the burner combustion substrate pores 424 may have a 3-dimensional structure in a region 422 of the substrate designed to promote certain flow or flame characteristics. A pore with the 3-D shape of a nozzle is specifically mentioned.

The shapes and distributions of pores can be mixed to produce desirable heat production, pressure drop across the cross-section of the substrate and combustion stability properties as illustrated by the embodiment shown in FIG. 4G. For a region 310F of the burner substrate porosity is generated by a regular pattern of slots 426 and holes 428 perforated in the substrate surface. Without being bound by theory, distributions of narrow slots 426 and holes 428 with small diameter tend to promote combustion stability, but increase the pressure drop across cross-section of the burner substrate by presenting a high resistance to the premix fuel-air flow. Wider slots 426 and holes 428 with large diameters decrease the pressure drop due to flow resistance, but may increase the tendency of flame blow-out, flashback and resonance instabilities. Empirically, the inventors have found that circular hole diameters between 0.5 millimeters and 2 millimeters and slots with width dimensions between 0.5 millimeters and 2 millimeters and length dimensions between 2 millimeters and 15 millimeters provide a practical balance of flow and stability characteristics. A circular hole diameter of 1 millimeter is specifically mentioned. A slot with width 1 millimeter and length of 6 millimeter is specifically mentioned. A regular pattern of holes, slots, or holes and slots promotes manufacturability, but the present disclosure is meant to encompass all regular and irregular patterns of holes or slots or holes and slots in combination with approximately equivalent premix fuel-air flow and combustion properties. The substrate temperature and pressure drop is also affected by the fraction of the burner substrate surface that is perforated to produce pores. Empirical results show that a perforated surface area of between approximately 5 percent, 6 percent, 7 percent, 8 percent, 9 percent or 10 percent of the total substrate surface area to approximately 20 percent, 22 percent, 24 percent, 26 percent, 28 percent, 30 percent, 32 percent, 34 percent, or 36 percent of the total substrate surface area provides practical control of the substrate surface temperature wherein the foregoing upper and lower bounds can be independently combined. The range 8 percent to 20 percent of the total substrate surface area is specifically mentioned.

There are several important advantages to the arrangements in the disclosed embodiments. Depending upon the specific parametric choices for design parameters (including pore size and density, the fuel-air flow velocity and combustion substrate geometry)—while the burner can be operated in a range of combustion modes from surface combustion to volume combustion, the geometry is suitable for stable suspended flame (SF) combustion applications. This is desirable since the resulting separation distance between the flamelet or flame front and the combustion substrate in SFF combustion: (a) relaxes the material demands on the substrate in the presence of high temperatures during operation, eliminating the need for insulation of the substrate; and, (b) reduces the risk of substrate material failure or contamination of the pores by combustion byproducts.

Semi-cone combustion substrate geometry also promotes uniformity of the combustion process over the entire interior surface of the substrate. FIG. 4H presents a perspective drawing showing a burner combustion system 416 comprising a semi-cone shaped combustion substrate 414. A premix fuel-air mixture 420 enters the burner casing 314 through the inlet conduit 418 and is distributed by the flow geometry in the annular region formed between the burner casing and the substrate. The mass flow of fuel-air mixture in a circumferential section 433 of the semi-cone combustion substrate is determined by the flow rate 424 through the distribution of pores 422 and the surface area of the substrate at that altitude of the semi-cone. At the proximal end 428 of the combustion substrate, P, the fuel-air flow rate is relatively high and the circumferential section surface area is low. Conversely, at the distal end 426 of the combustion substrate, D, the fuel-air flow rate is relatively low and the circumferential section surface area is high. The volume of the burner casing 416, the proximal (Dₚ) and distal (D_{d}) diameters of the semi-cone combustion substrate and the semi-cone angle, α, as measured from the axis 430 can be selected so that the fuel-air mass flow is uniform along the entire length of the substrate. Balancing the local fuel-air mass flow to achieve a uniform distribution of fuel-air mass flow into the flame front (and, therefore, heat generation, temperature, flow velocity, etc.) is a feature that distinguishes the embodiments comprising a semi-cone combustion substrate from other alternatives.

Moreover, the burner combustion substrate defines a combustion volume delineated by the interior surface of the substrate that is optimized for improved and complete combustion of the premix fuel-air mixture, homogeneous distribution of the flame front on the interior surface of the porous substrate (equivalently, diffuser), and uniformity of the resulting flow field of combustion products.

The desirable flow field and temperature distribution properties persist for a range of semi-cone burner substrate geometries. FIG. 4I illustrates an embodiment that shows a perspective drawing of a burner 416A comprising a semi-cone shaped combustion substrate 414A with an acute, non-zero substrate angle and proximal diameter equal to zero. A premix fuel-air mixture 420A enters the burner casing through the inlet conduit 418A and is distributed by the flow geometry in the annular region formed between the burner casing and the substrate. The mass flow of fuel-air mixture in a circumferential section of the semi-cone combustion substrate is determined by the flow rate through the distribution of pores 422A and the surface area of the substrate at that altitude of the semi-cone. The premix fuel-air flows through the pores of a semi-cone substrate. Also shown are the igniter 302 and the detector sensor 308 disposed on the substrate in a location away from the axis centerline.

FIG. 4J illustrates an embodiment that shows a perspective drawing of a burner 416B comprising a semi-cone shaped combustion substrate 414B with an acute, non-zero substrate angle. A premix fuel-air mixture 420B enters the burner casing through the inlet conduit 418B and is distributed by the flow geometry in the annular region formed between the burner casing and the substrate. The mass flow of fuel-air mixture in a circumferential section of the semi-cone combustion substrate is determined by the flow rate through the distribution of pores and the surface area of the substrate at that altitude of the semi-cone. The premix fuel-air flows through the pores of the semi-cone substrate. Also shown are the igniter 302 and the detector sensor 308 disposed on the substrate in a location on the axis centerline through a conduit to the burner head.

FIG. 4K illustrates an embodiment that shows a perspective drawing of a burner 416C comprising a semi-cone shaped combustion substrate 414C with substrate angle equal to zero. A premix fuel-air mixture 420C enters the burner casing through the inlet conduit 418C and is distributed by the flow geometry in the region formed between the burner casing and the substrate. The mass flow of fuel-air mixture is determined by the flow rate through the distribution of pores 422C and the surface area. Also shown are the igniter 302 and the detector sensor 308 disposed on the substrate in a location on the axis centerline through a conduit to the burner head.

FIG. 4L illustrates an embodiment that shows a perspective drawing of a burner 416D comprising a semi-cone shaped combustion substrate 414D with substrate angle equal to zero. A premix fuel-air mixture 420D enters the burner casing through the inlet conduit 418D and is distributed by the flow geometry in the region formed between the burner casing and the substrate. The mass flow of fuel-air mixture is determined by the flow rate through the distribution of pores 422D and the surface area. Also shown are the igniter 302 and the detector sensor 308 disposed on the substrate in a location away from the axis centerline.

FIG. 4M is similar to the embodiment shown in FIG. 4L, except the sensors 308, 302 are mounted on the side, instead of through the substrate plate.

Even when the fuel-air mass flow rate is increased into the volume combustion regime, the semi-cone geometry alters the cavity flame structure so that the power density is increased, and a smaller flame is required to achieve a prescribed level of heat generation. Because the fuel-air mass flow is equally distributed over the surface of the porous combustion substrate, when driven into a volume combustion regime the entire length of the flame is equally impinged by the premix fuel. Hence, the structure of the body of the flame—normally divided into cool and hot regions—is altered to produce a hotter, more efficient combustion process. As a result, the same heat generation capacity is achieved by a smaller flame size with higher power density, and more complete combustion can occur in a smaller burner cavity.

Moreover, semi-cone combustion substrate geometry promotes homogeneity and uniformity of the flow field exiting the burner casing. This is particularly important in apparatus comprising heat-generating burners for fluid heating applications utilizing, for example, shell-and-tube heat exchangers.

Towards this end, in certain embodiments a composite semi-cone combustion substrate is used when optimization of the combustion flow field over the height, H, requires a change in the local generator angle (alternatively, range of generator angles in the case of a general semi-cone). Otherwise, when optimization of the combustion flow field can be achieved using a single semi-cone, a semi-cone, truncated cone or frustum shape may be used.

Uniform combustion over the surface of the substrate and uniformity of the flow field exiting the burner contributes to an increase in thermodynamic efficiency of the combustion system. A result of the uniform flow field and temperature distribution of combustion products generated by the premix burner comprising a composite semi-cone combustion substrate is an increase in overall system thermodynamic efficiency. This is a particularly important result for applications like fluid heating where energy efficiency and reduction of environmentally hazardous byproducts are key.

The various components of the premix fuel burner combustion system can each independently comprise any suitable material. Use of a metal is specifically mentioned. Representative metals include iron, aluminum, magnesium, titanium, nickel, cobalt, zinc, silver, copper, and an alloy comprising at least one of the foregoing. Representative metals include carbon steel, mild steel, cast iron, wrought iron, a stainless steel such as a 300 series stainless steel or a 400 series stainless steel, e.g., 304, 316, or 439 stainless steel, Monel, Inconel, bronze, and brass. Specifically mentioned is an embodiment in which the premix fuel burner combustion system components each comprise steel, specifically stainless steel. The premix burner combustion system may comprise a burner head, a combustion substrate, a baffle, a furnace wall that can each independently comprise any suitable material. Use of a steel, such as mild steel or stainless steel this mentioned. While not wanting to be bound by theory, it is understood that use of stainless steel in the dynamic components can help to keep the components below their respective fatigue limits, potentially eliminating fatigue failure as a failure mechanism, and promote efficient heat exchange.

A flat substrate (annular substrate with D_{d} and Dₚ prescribed) is the geometrical limit of a sequence of semi-cone combustion substrate configurations within the inventive species sharing a common furnace diameter. A family of semi-cone substrates sharing a common furnace diameter (e.g., D_{d} in FIG. 3) possesses the important property that the surface area of the substrate supporting the pores increases with decreasing substrate angle, α (equivalently, with increasing semi-cone height). This enables those skilled in the art of burner design to select the combustion substrate geometry to achieve a heat production capacity (equivalently, burner surface load, the amount of heat produced by combustion per unit surface area of substrate surface in Watts per centimeter squared). That is, for a prescribed furnace configuration with distal diameter (D_{d}) and proximal diameter (Dₚ), the surface area of the substrate is minimum for a substrate angle, α=90°, and increases with decreasing substrate angle. If the design target burner load can be achieved using a desired perforation pattern and density on a flat (or annular) substrate (α=90°) at a prescribe temperature, this option provides configuration that is easily and cheaply manufactured and still retains desirable premix flow, heat distribution, temperature and flame combustion characteristics. If the burner load cannot be achieved using this minimal surface area, a semi-cone substrate with angle 0<α<90° is used, which increases the available surface area and, thereby, total burner system heat production capacity.

The design of the perforation pattern, dimensions and distributions are separate inventive concepts from the semi-cone substrate structure, and the resulting flow and temperature properties can be exploited in various distinct configurations. The desirable flow, temperature and combustion properties such a pore pattern can be expected to have similarities in two different semi-cone geometries, but will also have distinct properties that may be exploited by one skilled in the art of burner design.

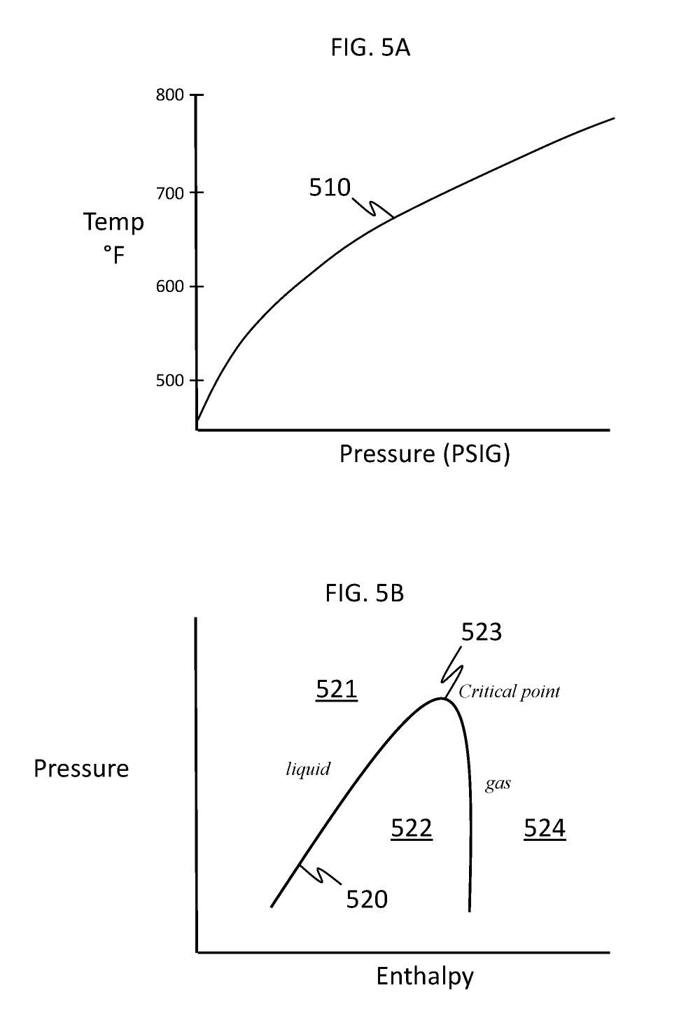

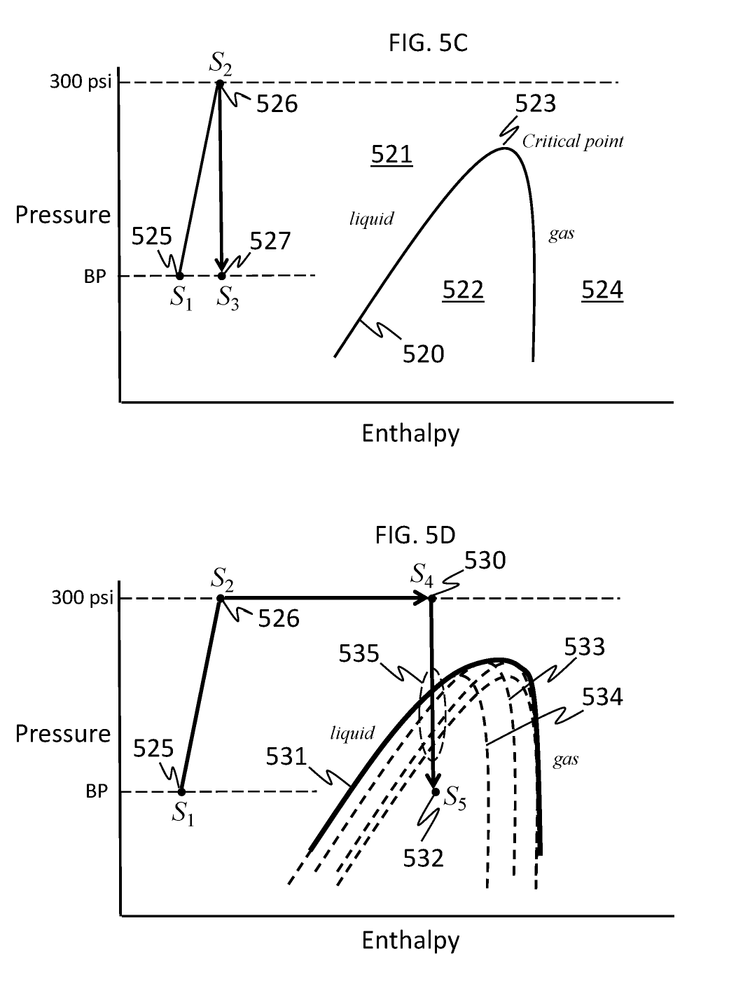

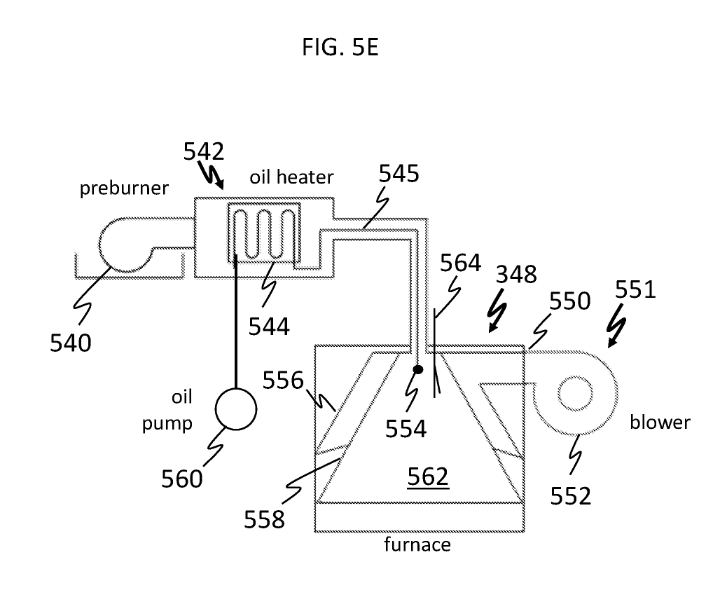

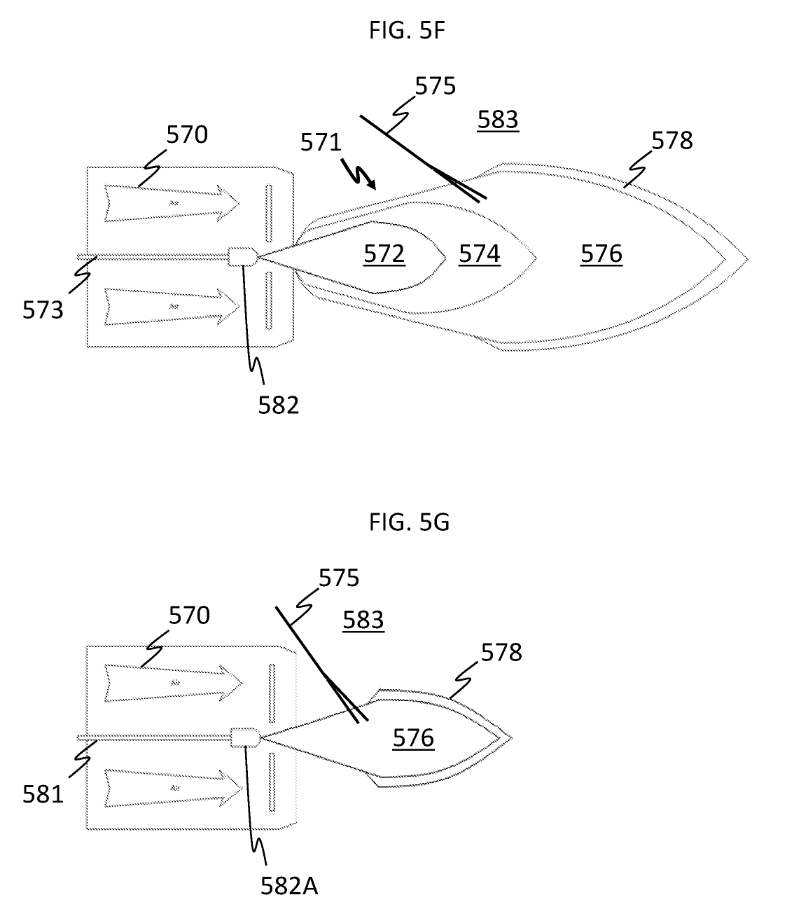

The inventors have unexpectedly discovered that embodiments of fuel oil combustion systems based on isenthalpic expansion-enabled (flash) combustion can alleviate many of the disadvantages of known oil fuel-based systems described above and, moreover, can exploit advantages of the cavity geometries described above for the premix gaseous fuel combustion systems when used in a dual fuel configuration. FIG. 5A to FIG. 5D illustrates the principles. Fuel oils in general use in commercial and industrial applications are a combination of species of hydrocarbon chains of various lengths typically obtained by petroleum distillation, particularly alkanes, cycloalkanes and aromatics. Each component species possesses chemical properties (e.g., boiling point) particular to that species, and the composite fuel oil inherits its bulk properties from the individual components.

For example, FIG. 5A shows the curve 510 denoting the bubble point of a typical liquid fuel denoting, for each pressure, the temperature at which the first bubble is formed for the most volatile (typically, shortest chain) component of a composite fuel. This represents the thermodynamic state where the lightest component transitions from a liquid state to a gas or, alternatively, the pressure-temperature combination where the mixture is saturated with the gas of the most volatile constituent.

FIG. 5B shows the corresponding liquid-gas saturation diagram for a typical isolated component in the mixture as a function of enthalpy (system total heat) and pressure. The curve 520 of boiling points separate regions of where the fuel is a liquid 521, mixed liquid and gas 522, and gas 524, with a critical transition point 523 where no saturated liquid exists.

The operating temperature and pressure for isenthalpic expansion enabled burner combustion depends upon the oil components and properties in the fuel. However, in practical applications using common fuel oils, a preheating temperature between 350 degrees Fahrenheit and 900 degrees Fahrenheit is specifically mentioned. Also, pre-pressurization of the fuel oil between 200 PSI and 500 PSI is specifically mentioned. Combustion burner operation enabled by isenthalpic expansion using fuel oil at approximately 700 degrees Fahrenheit and a pressure of 300 PSI is also specifically mentioned. Other values for temperature and pressure may be used if desired, provided it results in the desired isenthalpic expansion discussed herein.

FIG. 5C illustrates the thermodynamics conditions for a liquid fuel combustion system. Again, the boiling point curve 520 separates regions where the fuel is a liquid 521, mixed liquid and gas 522, and gas 524 with critical point 523. Fuel stored at barometric pressure 525, in liquid state S₁, from the storage location is pumped under pressure (300 pounds per square inch (psi), for example) into the dispersion nozzle as discussed in FIG. 2B. The work done to increase the liquid fuel pressure slightly increases the system total energy through heat conversion. As a result, the substantial change in pressure and small change in enthalpy alters the closed system state from S₁ to a new thermodynamic state 526, S₂, also in a liquid state.

An isenthalpic transition occurs when—for a fixed enthalpy—a pressure change causes a change of state of the mixture. In FIG. 5C, once the liquid fuel is dispensed through the dispersion nozzle (295 of FIG. 2B), the pressure drops back down to the local barometric pressure to a new state 527, S₃, still a liquid. In the conventional case, the increase in liquid fuel pressure by the oil pump has merely moved the liquid from the storage tank through the dispersion nozzle, and imparted linear momentum to the spray of oil droplets emanating from the nozzle.

The inventors have surprisingly discovered that these thermodynamics state changes can be utilized to mitigate or eliminate the disadvantages inherent in an oil jet burner apparatus. The principle is illustrated in FIG. 5D. As before, fuel stored at barometric pressure 525, in liquid state S₁, from the storage location is pumped under pressure (300 psi, for example) to the burner. Also, as before the work done to increase the liquid fuel pressure slightly increases the system total energy through heat conversion, which together with the pressure change, alters the closed system state from S₁ to a new thermodynamic state 526, S₂, also in a liquid state. The pressurized liquid is then heated to raise the closed system enthalpy to a new liquid state 530, S₄, but below the saturation point (at the elevated pressure) for the composition fuel for all the constituent component species. Thus, even at the elevated pressure and enthalpy, no gas bubbles form in the oil conduit. In doing so, it passes through the corresponding point on the fuel's bubble point curve 531, and through many (if not, all) the saturation points 535 of the fuel's constituent components, from most volatile 534 to less volatile 533. At the new thermodynamic state 532, S₅, the fuel is in a mixed liquid and vapor state, where combustible gas is released on short time scales (“flashing”). In this state, a proportion of the fuel mass fraction is freed and readily available for combustion.

A first feature of the present disclosure is that the inventors have surprisingly discovered that isenthalpic expansion of fuel oil can be exploited in fluid heating system combustion systems. FIG. 5E shows a high-level functional block diagram of an embodiment of a process for isenthalpic oil combustion.

When burning oil, liquid fuel contained in a storage location is conveyed by an oil pump 560 to a preheater; for example, a preburner 542 comprising a blower 540 and heat exchanger 544 (oil heater). In an alternative embodiment, the preheater may comprise an electric element. The oil pump 560 and heat exchanger 544 (alternatively, electric element or an equivalent) increase the oil pressure and enthalpy (total heat) by heating the oil (e.g., by a secondary combustion process, or electric heating element). The hot, pressurized oil is conveyed through a conduit 545 into the fluid system burner combustion cavity 562 within the furnace 548 where it is dispersed by an oil nozzle 554. As the hot oil enters the enlarged combustion volume 562 through the nozzle 554, it experiences an isenthalpic pressure drop, and the oil mixture changes state to a composition of liquid and gas. The oil dispersed by the nozzle 554 is mixed with oxygen (air) forced into the burner by a blower 552 through an inlet conduit 550. An igniter 564 is used to combust the oil vapor and the resulting ambient heat released causes combustion of the remaining liquid fraction.

Thus, although not wanting to be bound by theory, the inventors have discovered that the benefits of isenthalphic expansion can be realized by apparatuses comprising a means 542 for preheating and pressurizing the liquid fuel, a means 554 for dispersing the heated fuel under pressure into a combustion volume 562, and a means for delivering oxygen (typically, ambient air) into the combustion volume 551. The apparatus may further comprise a means 564 for igniting the resulting mixed fuel vapor-gas and air when operated from a cold condition.

The inventors have also surprisingly discovered that a second feature pertaining to embodiments of the present disclosure is that fuel must be controlled throughout the process to achieve the correct thermodynamic condition. Maintaining the correct fuel thermodynamic state requires, at distinct stages, matching the system temperature and pressure requirements to the material and chemical properties of the fuel using the geometry of the apparatus, and the combustion stoichiometry and dynamics.

For example, in the system depicted in FIG. 5E, the oil heater 542 is used to preheat the pressurized oil to a condition below its bubble point. Thus, the preheated, pressurized oil remains in a fully liquid state as it is delivered by the oil conduit 545 to the dispersion nozzle 554. Thus, when the under-saturated high-pressure, high-temperature fuel arrives at the nozzle 554 it is in a liquid state free of gas bubbles so that it can be safely transported to the combustion volume without risk of ignition or boiling. If the temperature of the preheater 544 (hence, the liquid fuel) goes above the bubble point of the fuel at that pressure, the constituent species comprising the oil can start to separate. This will cause the light (short hydrocarbon chain) species to vaporize or boil, and the viscosity of the remaining liquid fuel will increase. This can cause safety issues due to the fuel vapor in the oil conduit 545, clogging of the dispersion nozzle 554, solid deposits in the oil conduit 554, and apparatus metal temperatures that can cause fatigue and failure.

Moreover, the high pressure of the liquid fuel through the nozzle promotes the generation of a spray of fine droplets from the dispersion nozzle. Because the liquid fuel is preheated, once the fuel is dispersed into the larger combustion volume 562 by the nozzle, the droplets are already carrying the heat required for vaporization. Hence, the fuel is combustible immediately after the pressure drop in the presence of oxygen (air) delivered into the combustion volume by the blower 551, since the products of isenthalphic expansion are injected into a region that already includes a high volume of gas. This process can be referred to as instantaneous atomization-vaporization.

A third feature of the present disclosure is that the inventors have surprisingly discovered that embodiments comprising elements of both inward-firing gas burner geometries and isenthalpic oil burner components may be integrated to provide dual fuel combustion systems that also alleviates many of the disadvantages described above for gas burners and oil jet burners. Referring again to FIG. 5E, when used to combust gaseous fuel, a blower 552 forces a premix(ture) of gas and air (oxygen) through an inlet conduit to an outside of a porous combustion substrate 558. The flow of premix gas and air can be guided and distributed by a varied of means, including a guide baffle 558, to ensure a uniform distribution. The premix fuel passes inward (into the combustion cavity) through the porous combustion substrate 558 where it is ignited by a (e.g., spark) igniter 564. Depending upon the premix fuel composition, material details of the substrate, flow pressure and temperature, the gas combustion can be operated in surface, suspended flame front or volume combustion modes.

A fourth feature of the present disclosure is that the inventors have surprisingly discovered that embodiments utilizing isenthalpic expansion of a preheated, pressurized fuel oil can produce short flame envelopes compatible with highly compact combustion systems. FIG. 5F shows a diagram depicting combustion flame 571 resulting from the burning of unheated oil atomized into droplets through a nozzle 582, typical of the device shown in FIG. 2B. The atomizing nozzle 582 produces a stream of oil droplets into a spray occupying a first region 572 of the combustion flame envelope 571 driven by the momentum of the fluid entering the nozzle through the oil conduit 573. The elevated temperature in the combustion volume heats the liquid oil droplets which vaporize the lighter compounds and break (“crack”) some long-chain hydrocarbon constituents into lighter, more volatile compounds. This liquid-vapor mixture—still too rich to combust—is driven downstream through a second region 574 within the flame envelope 571. The released vapor begins mixing with oxygen (air) 570 conveyed under pressure through the blast tube into the combustion volume 583 in a third region 576 within the flame envelope 571. Once sufficient mixing occurs between the fuel vapor and air has been achieved, the elevated temperature within the chamber (alternatively, an igniter 575) ignites the lean fuel-air mixture to produce sustained combustion, which also cracks the remaining long-chain hydrocarbons to produce additional combustible fuel vapor. Finally, free carbon is burnt within a fourth region 578 within the flame envelope 571 and soot (unburnable particulates) is formed which is conveyed, along with the hot combustion gases and byproducts, downstream of the flame.

The inventors have unexpectedly discovered that isenthalpic expansion of heated oil can be used to substantially shorten the flame length of an oil combustion system, by nearly eliminating the first and second flame regions illustrated in FIG. 5F required to vaporize the atomized oil mixture. Consistent with the block diagram in FIG. 5E, in FIG. 5G oil at an elevated enthalpy state entering the furnace under pressure through the oil conduit 581 into a dispersion nozzle 582A. Once the oil mixture is dispersed into the enlarged combustion volume 583 its pressure drops producing a change of thermodynamic state. Because the time scale for the isenthalpic state change is much faster than the rate of dispersed oil flow, vaporization of the volatile oil components occurs virtually instantaneously at the nozzle 582A opening. The oil vapor produced by isenthalpic expansion mixes with oxygen (air) 570 conveyed into the combustion volume 583, producing a lean mixture in a region 576 close to the nozzle 582A suitable for combustion. The elevated temperature within the chamber (alternatively, an igniter 575) ignites the lean fuel-air mixture to produce sustained combustion. Free carbon is burnt within a second region 578 within the flame envelope 578 and soot (unburnable particulates) is formed which is conveyed, along with the hot combustion gases and byproducts, downstream of the flame.

FIG. 6A shows a cutaway diagram of an embodiment of an inward-firing premix burner comprising a semi-cone combustion substrate combined with an isenthalpic oil burning apparatus based on the principles described above, specifically noting that some advantages of the burner embodiments discovered by the inventors are not limited to the composite semi-cone geometry and admit other cavity embodiments. In the embodiment shown, a semi-cone shaped combustion substrate 630 is disposed between the burner top head 602 and the inner surface of the furnace 618. In this embodiment, the burner combustion substrate is a right circular frustum wherein the proximal edge 634 is a planar circle perpendicular to the axis 610 with diameter Dₚ and distal edge 612 a planar circle perpendicular to the axis 610 with diameter D_{d}, with height H.

Dimensions of the combustion substrate depend upon the burner power, capacity, performance and size requirements of a specific application. Proximal diameters (Dₚ) between 1 inch and 59 inches is specifically mentioned. Distal diameters (D_{d}) between 2 inches and 60 inches is specifically mentioned. Substrate height (H) between 1 inch and 60 inches is specifically mentioned.

The semi-cone sections of the burner combustion substrate angle, α, may have any suitable generator angle between 1 degree, 2 degrees, 3 degrees, 4 degrees, 5 degrees, 10 degrees to 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees, 50 degrees, 60 degrees, 70 degrees, 80 degrees, 85 degrees and 90 degrees wherein the foregoing upper and lower bounds can be independently combined. For the right circular semi-cone, right circular truncated cone, and the right circular frustum, the burner combustion substrate angles between 18 degrees and 35 degrees is specifically mentioned. For the right circular semi-cone, right circular truncated cone, and the right circular frustum, the burner combustion substrate angle of 25 degrees is also specifically mentioned. Notice that a burner combustion substrate angle of 90 degrees corresponds to a flat structure, a degenerate semi-cone that is the limit of a family of semi-cones with circumference diameter, D_{d}. For the right circular semi-cone, right circular truncated cone, and the right circular frustum, the burner combustion substrate angle of 90 degrees is specifically mentioned.

When operated to burn a premix gas and air composition, the burner combustion substrate is porous to the flow of premix fuel-air mixtures predominately in a vapor state. Substrate pores 626 are distributed over the area of the burner combustion substrate to support a flame front 628 near the interior surface. (The pore 626 size in a local area 624 are exaggerated in the diagram for clarity and are not meant to be to scale.) The combustion process may be monitored by a sensor 604 which can detect if the flame is extinguished.

In the embodiment shown a premix(ed) fuel-air mixture 648 enters the inlet 632 of the burner and flows around and through the burner combustion substrate inward toward the axis 610. The fuel-air mixture ratio is composed so that the premix fuel is ignited near the interior surface to form a flame 628 suspended over the interior surface of the burner combustion substrate.

When operated to burn a fuel oil using isenthalpic expansion, the burner combustion substrate defines (part of the) cavity for the combustion of the oil mixture as well as the pathway for air required in the combustion process. Preheated fuel oil is conveyed under pressure through an oil conduit 638 and into a dispersion nozzle 640. The nozzle 640 disperses the oil under pressure at a heightened enthalpy state into the combustion cavity delineated by the porous substrate 630 and the inner wall of the furnace 618. Virtually immediately (for all practical purposes) after the oil composition is dispersed into the combustion volume by the nozzle 640, a significant mass fraction vaporizes and is mixed with air entering through the inlet conduit 632, through the space between the furnace wall 618 and the porous substrate 630, through the porous substrate 630 and into the combustion cavity. The oil vapor and air mixture is ignited either by the elevated temperature or a (e.g., spark) igniter 636 to achieve a sustained combustion process.

In a boiler application comprising a shell and tube heat exchanger, the combustion products (e.g., hot gases, particulate byproducts)—created either from the combustion of the premix gas-air mixture or by the isenthalpic oil expansion process—flows towards the tubesheet 616 where they pass through the openings 608 of the heat exchanger tubes 614. Heat generated by the combustion process is transferred across the walls of the heat exchanger tubes 614 to production fluid occupying the space between the outer surfaces of the furnace 620 and heat exchanger tubes 614 and the inner surface of the pressure vessel 618, sealed at one end by the boiler top head 606.

In the embodiment shown of an integrated dual-fuel combustion system in FIG. 6A, when operated as a gas burner, premix(ed) fuel and air enter the inlet conduit 632 and, after passing inward through the porous substrate 630 into the inner volume defined by the semicone substrate, supports surface or suspended flame combustion on or near the inside surface of the combustion substrate 630. When operated as a short-flame length liquid fuel burner, air enters the inlet conduit 632 and, after passing inward through the porous substrate 630 into the inner volume defined by the semicone substrate, mixes with the spray emanating from the oil dispersion nozzle 640 to support combustion. We shall use the convention that for the flat plate limiting case, inward flow is defined to be consistent with the flow direction through the family of cone structures for which the flat plate geometry is the natural limiting case; that is, from the region where the air flow enters the burner 648 through the conduit 632, through 626 the porous structure, into the combustion region 649. In both cases, uniform distribution of the flow stream from the inlet 632 through the substrate 630 is desirable. This can be achieved by guiding the air or premix flow using a baffle. In the embodiment depicted in FIG. 6, the baffle comprises a semicone structure 642 with proximal 644 and distal 646 edges shaped to direct air or premix flow to the outer surface of the substrate 630.

FIG. 6B shows a cross-sectional diagram of the instrumented burner top head 656. Heated liquid fuel 650 is conveyed to the burner under pressure through an oil conduit 652 to the dispersion nozzle 662. The dispersion nozzle 662 is disposed on the burner top head 656 by a mount 660 such that the nozzle pores are displaced from the burner top head by a distance 504, h. For cold operational conditions, the fuel-air mixture combustion can be initiated by a igniter; for example, a spark igniter 666 which uses a spark generated between two electrodes 666, or a functional equivalent thereof.

A fifth feature of the present disclosure is that the inventors have surprisingly discovered that embodiments utilizing isenthalpic expansion of a preheated, pressurized fuel oil are amenable to standard burner temperature control methods common to fluid heating systems. That is, despite the fact that the incorporation of instantaneous atomization-vaporization by isenthalpic expansion has significantly altered the combustion dynamics and shortened the flame structure, methods for controlling and modulating the burner output characteristics, including control of the fuel spray at the nozzle, can be used. The dispersion nozzle is responsible for creating an atomized spray of from the liquid stream of high-pressure, enhanced-enthalpy fuel in a geometrical pattern that promotes mixing and complete combustion. For example, without being limited to specific nozzle configurations, properties, characteristics or properties, Fulton Oil Nozzle Dual Fuel Burner (FT-0400-C-FT-1400-C) provides one example of an oil dispersion nozzle applicable to the present disclosure. FIG. 6C shows a simplex nozzle 671 comprising a liquid oil conduit 676, nozzle adapter 674, filter 672 and the spray nozzle 670. Control of the oil dispersed by the nozzle is accomplished by varying the pressure of the fuel into the oil conduit 676, a technique known by those skilled in the art of boiler design and manufacturing. Other nozzles may be used if desired provided they provide the desired function and performance described herein.

A more sophisticated method of controlling the burner output and performance is illustrated in FIG. 6D depicting the use of a modulating nozzle 671B. Preheated, pressurized fuel is delivered to the nozzle 671B by the oil conduit 676 to the nozzle fuel inlet 690. Fuel is directed through the oil nozzle adapter 694 and the pilot tube assembly 696 and to the nozzle head 698. The nozzle head 698 atomizes the fuel stream and directs the resulting spray into the combustion volume in a geometric pattern; for example, in a cone-shaped pattern at a prescribed design dispersion angle is specifically mentioned. Residual oil is directed through a return tube 695, to an outlet port 692 and away from the nozzle by an outlet conduit 693. Other nozzles may be used if desired provided they provide the desired function and performance described herein.

The fuel nozzle head pressure and flow rate is modulated by a control valve 697 disposed on the outlet conduit 693. An actuator 691 receives a control signal 693, C, which acts to vary the fuel flow pressure in the outlet conduit 693. Increasing the return flow pressure in the return conduit 693 acts to increase the nozzle fuel pressure and the causes more fuel to be atomized and ejected by the dispersion nozzle 698 into the combustion volume, thereby raising the burner temperature.

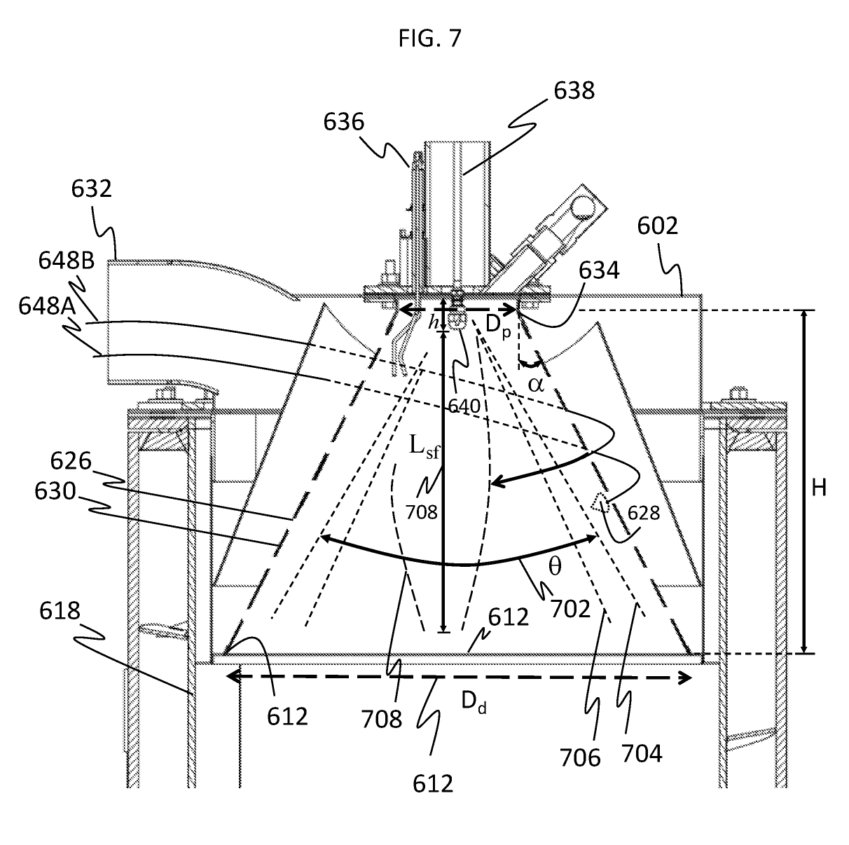

A sixth feature of the present disclosure is that the inventors have surprisingly discovered that the combustion volume geometry of embodiments comprising dual-fuel premix gas and isenthalpic expansion of a preheated, pressurized fuel oil elements can be optimized to concurrently achieve high performance of both the premix and oil operating modes. FIG. 7 shows a cross-sectional diagram of an embodiment of an inward-firing premix burner comprising a semi-cone combustion substrate 630 combined with an isenthalpic oil burning apparatus based on the principles described above, specifically noting that some advantages of the burner embodiments discovered by the inventors are not limited to the composite semi-cone geometry and admit other cavity embodiments. In the embodiment shown, a semi-cone shaped combustion substrate 630 is disposed between the burner top head 602 and the inner surface of the furnace 618. In this embodiment, the burner combustion substrate is a right circular frustum wherein the proximal edge 634 is a planar circle perpendicular to the axis 610 with diameter Dₚ and distal edge 612 a planar circle with diameter D_{d}, with height H. When operated as a premix gas burner, a premixture of gas fuel and air enters the burner through the inlet conduit 632, flow 648A in the space between the outside surface of the combustion substrate 630 and the inner wall 618 of the furnace, passes inward through the pores 626 in the combustion substrate 630, and is ignited to support either a surface or suspended flame 628 combustion process. Details of the embodiment operated in this mode were previously described in U.S. Provisional Application No. 62/634,476 and U.S. Provisional Application No. 62/634,520.

When operated as an oil burner, the semicone combustion substrate defines a combustion volume (equivalently, combustion cavity) for the combustion of liquid fuel based on isenthalpic expansion combustion and instantaneous atomization-vaporization. Preheated liquid fuel under pressure is delivered to the burner through an oil conduit 638 to the dispersion nozzle 640. The dispersion nozzle is disposed on the burner top head 602 at an offset distance, h. Liquid fuel is dispersed by the nozzle 640 in a spray pattern; a spray pattern in the shape of a cone with a dispersion angle 702, Θ, is specifically mentioned. When dispersed by the nozzle at a particular dispersion angle 702, Θ, the atomized fuel spray expands in a conical shape concentrated between an inner 706 and outer 704 dimension. Once the atomized liquid spray enters the combustion volume in this geometry, it vaporizes very rapidly. Air enters the burner system through the inlet port 632, flows 648B in the space between the outside surface of the combustion substrate 630 and the inner wall 618 of the furnace, passes inward through the pores 626 in the combustion substrate 630, and enters the combustion volume to be mixed with the fuel spray and ignited, either by the autoignition, gas pilot or by a (e.g., spark) igniter 636.

The envelope of the burner flame 708 that results from igniting the mix vaporized fuel and air has a length 708, L_{sf}, and is contained partially or entirely within the cavity defined by the combustion substrate. For this embodiment as described, a number of critical parameters define the characteristics of the combustion volume, including the combustion substrate proximal edge diameter, Dₚ, combustion substrate distal edge diameter, D_{d}, the substrate cone angle, α, the surface area of the combustion substrate, A, the nozzle dispersion angle, Θ, and the nozzle offset distance, h. Several important considerations affect choices for these parameters, depending upon the size, capacity and performance requirements of the burner system, including (but not limited to):

Substrate distal edge diameter, D_{d}: Typically, equal to the inside diameter of the inner wall of the furnace 618;

Substrate cone angle, α: Small substrate cone angles contribute to smaller deviations of the resulting flow stream of hot combustion gases and byproducts from the burner axis, since this flow stream is driven (in part) by the air stream through the porous combustion substrate. However, larger substrate cone angles promote mixing of fuel vapor and air within the combustion volume.

Substrate proximal edge diameter, Dₚ: Determined by the distal edge diameter, D_{d}, the substrate cone angle, α, and the substrate cone height, H.

Dispersion nozzle angle, Θ: Small dispersion angles prevent impingement of the atomized oil spray on the combustion substrate 630, but results in poorer air-fuel mixing and, hence, less complete combustion. Conversely large dispersion angle promotes mixing and stable combustion but can risk impingement of oil on the inner surface of the combustion substrate 630 leading to fouling or the substrate pores.

Dispersion nozzle offset, h: An important parameter used in conjunction with the dispersion angle, Θ, to prescribe the oil spray geometry. Larger nozzle offset better utilize air flow behind the nozzle but exposes the nozzle to higher flame temperatures. Smaller offset displacements risk oil impingement on the combustion substrate.

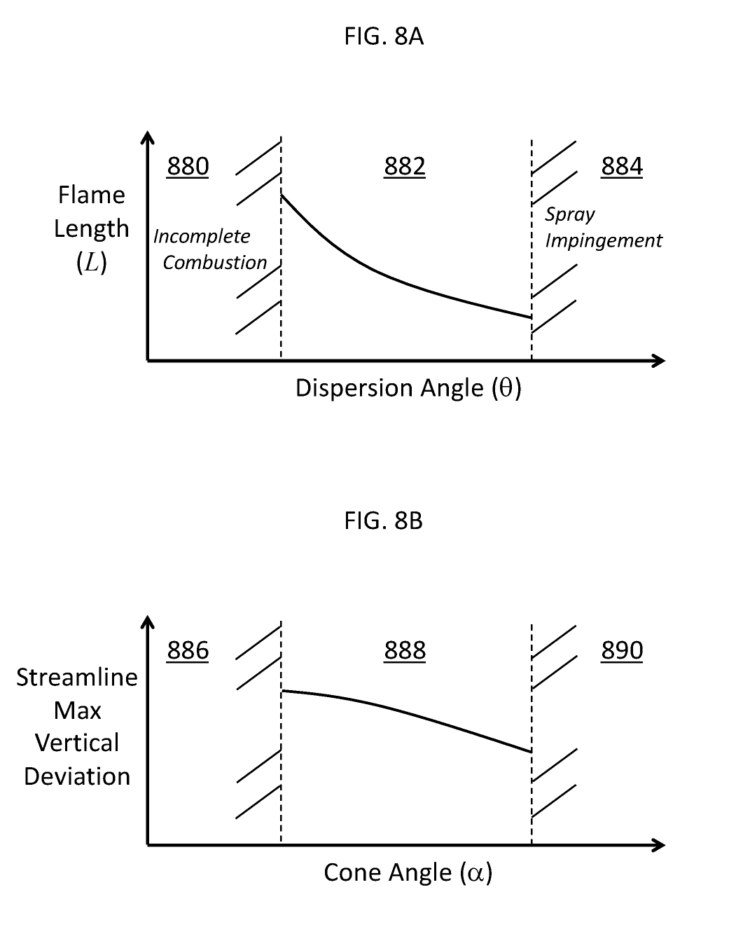

The tradeoffs described above between the nozzle dispersion angle, Θ, and the substrate cone angle, α, is illustrated in FIG. 8A and FIG. 8B. Useful values for the nozzle dispersion angle, Θ, are limited below by a range 880 that produces poor mixing and incomplete combustion, and limited above by a range 884 that risks fuel spray impingement on the inner wall of the combustion substrate, as shown in FIG. 8A. For a range 882 of values in between these limitations, higher values of dispersion angle produce shorter flame lengths compatible with compact duel fuel burner systems.

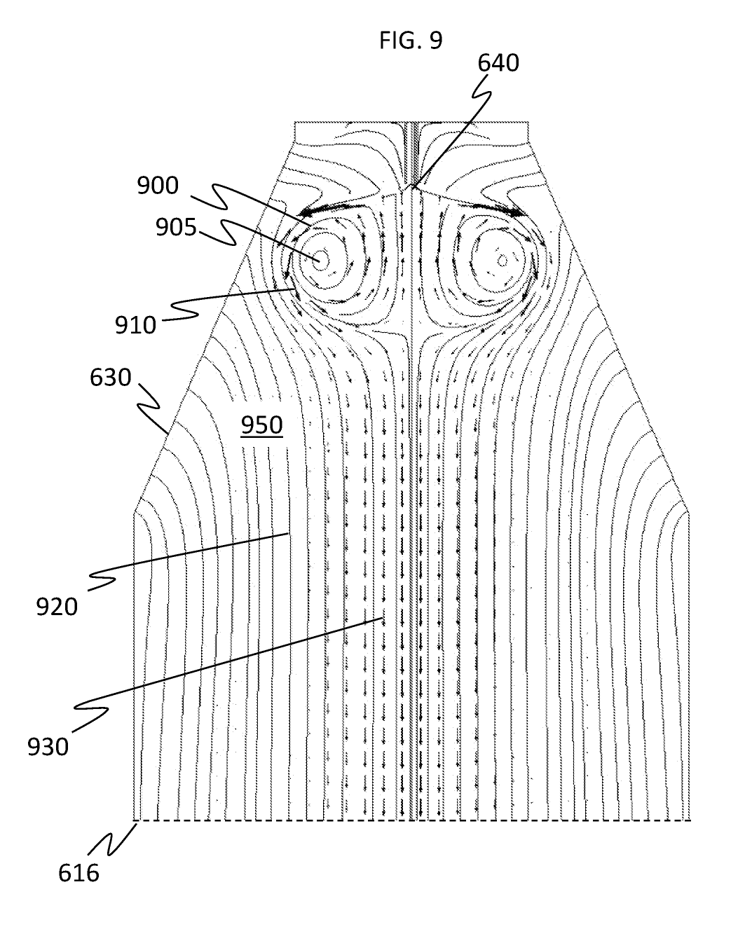

Similarly, useful values for the substrate cone angle, α, are limited to the range of acceptable values discussed herein for a desired burner design, as shown by vertical dashed lines in FIG. 8B, which have corresponding values of streamline maximum vertical deviation (e.g., see flow streamlines 920 in FIG. 9). For a range 888 of values in between these limitations, higher values of substrate cone angle, α, produce flow streams of hot combustion gases and byproducts that deviate less from parallel to the burner axis. Thus, in the case of boiler applications using heat exchanger tubes disposed on a tube sheet perpendicular to the furnace wall, the flow stream is oriented to efficiently enter the heat exchanger tubes.

FIG. 9 displays numerical results for a computational fluid dynamic simulation of the air stream flow for the embodiment depicted in FIG. 7. For this simulation, the combustion substrate distal edge diameter, D_{d}, equal 0.48 meters; the substrate cone angle, α, equals 41 degrees; the surface area of the combustion substrate, A, equals 0.28 meters squared; the nozzle dispersion angle, Θ, equals 140 degrees; and the and the nozzle offset distance, h, equals 50 millimeters. FIG. 7 shows flow streamlines 920 superimposed on flow velocity vectors 910. The air flow enters the combustion volume 950 through the porous substrate 630. Near the oil dispersion nozzle, 640, two vortices 905 are formed, wherein the flow 900 cycling near the vortex is low velocity (in this case, approximately 2 meters per second). As the flow is transported through the combustion volume 950 toward the distal end 616 of the furnace, the geometry of the combustion volume and the fluid dynamic forces cause the flow streamlines 920 to be oriented parallel to the burner axis with steady state laminar flow velocities near the center (in this case, approximately 9 meters per second).

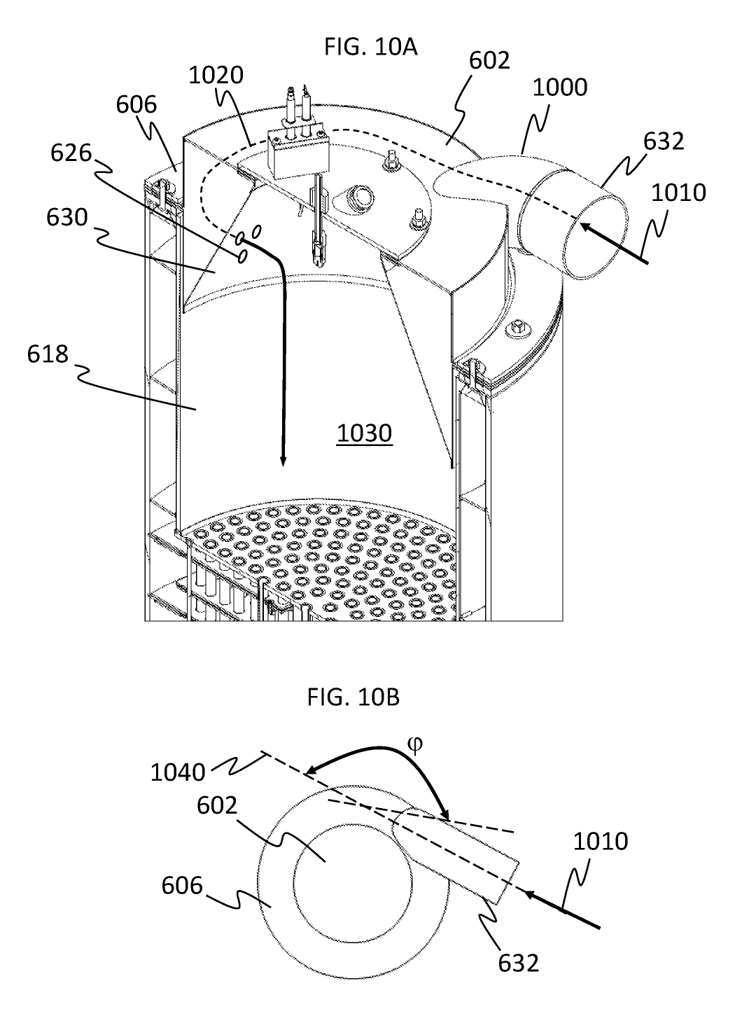

A seventh feature of the present disclosure is that the inventors have surprisingly discovered that the use of tangential or oblique inlet ports for air or premix gas-air mixtures in embodiments comprising dual-fuel premix gas and isenthalpic expansion of a preheated, pressurized fuel oil elements can obviate the requirement for baffles to guide and direct the incoming flow stream. FIG. 10A shows a perspective diagram of an embodiment of an inward-firing premix burner comprising a semi-cone combustion substrate 630 combined with an isenthalpic oil burning apparatus based on the principles described above, specifically noting that some advantages of the burner embodiments discovered by the inventors are not limited to the composite semi-cone geometry and admit other cavity embodiments. In the embodiment shown, a semi-cone shaped combustion substrate 630 is disposed between the burner top head 602 and the inner surface of the furnace 618. The burner head 602 is disposed on the furnace top head 606. The inlet port 632 directs a premix fuel-air composition (when operated as a gas burner) or air (when operated as an oil burner), through a coupling conduit 1000 and into the space between the combustion substrate 630 and the inner furnace wall 618. The stream of gas-air or air circulates 1020 in the interstitial space and through the pores 626 of the substrate 630 into the combustion volume 1030.

In the embodiment shown in FIG. 10A, the inlet port 1010 and the coupling conduit 1000 direct the flow stream 1010 at an angle oblique to the tangent 1040 of the inner furnace wall, as shown in FIG. 10B, disposed on the burner top head 602 secured to the furnace by the furnace top head 606. The inlet flow angle, φ, prevents the gas stream from impinging on the adjacent substrate and introduces an inherent circulation in the flow path. The inlet flow angle is between 0 degrees, or 5 degrees, or 10 degrees, or 15 degrees, or 20 degrees and 160 degrees, or 165 degrees, or 170 degrees, or 175 degrees, or 180 degrees, where the upper and lower bounds may be independently combined. The range 0 degrees to 180 degrees is specifically mentioned. Also, the inlet flow angle of 140 degrees is specifically mentioned.

An eighth feature of the present disclosure is that the inventors have surprisingly discovered that embodiments comprising dual-fuel premix gas and isenthalpic expansion of a preheated, pressurized fuel oil elements, production of nitrogen oxide (NOx) byproducts can be reduced. The primary cause of NOx emissions are derived from nitrogen in the fuels used or from nitrogen in the combustion air (thermal NOx). For natural gas-fired and No. 2 oil-fired boilers, thermal NOx represents the majority of NOx produced from commercial and industrial boilers. Thermal NOx emissions increase with increasing residence times of combustion products at high temperatures and are affected by oxygen availability in the boiler combustion zone. Embodiments of the present disclosure reduce the dwell times due to the compactness of the burner and smooth, laminar flow through the combustion system, and the efficient control of oxygen present in the combustion volume.

An ninth feature of the present disclosure is that the inventors have surprisingly discovered that embodiments comprising dual-fuel premix gas and isenthalpic expansion of a preheated, pressurized fuel oil elements admit the use of different shapes for the combustion volume and still can achieve compact, thermally efficient design objectives. In what follows is described embodiments comprising combustion volumes wherein the substrate that delineates all or part of the combustion volume is defined by specific choices of composite semicone (including cylindrical components) or cylindrical elements.

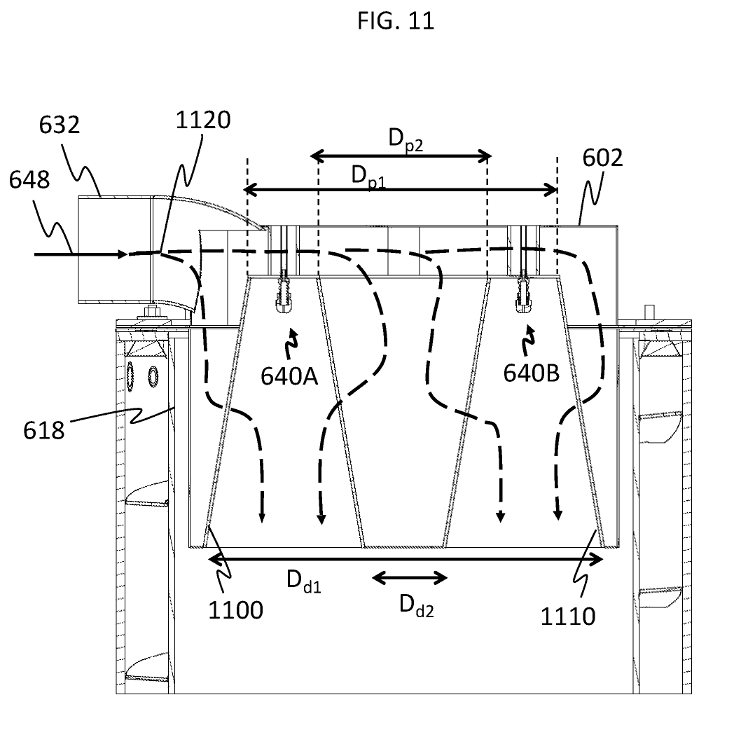

FIG. 11 shows a cross-sectional diagram of an embodiment comprising dual-fuel premix gas and isenthalpic expansion of a preheated, pressurized fuel oil elements and further comprising an inward-firing annular semicone combustion substrate. The annular semicone substrate comprises two concentric semicone surfaces, a first semicone substrate surface 1100 with a proximal diameter, Dₚ₁, a distal diameter, D_{d1}, and height H₁; and a second semicone substrate surface 1110 with a proximal diameter, Dₚ₂, a distal diameter, D_{d2}, and height H₂. (Proximal to the air inlet; distal from the air inlet.) In this embodiment D_{p2<}D_{p1,}D_{d2<}D_{d1} and H1 and H2 can be any height required by the compactness, performance and burner capacity requirements, otherwise unrelated. One or both of the semicone substrate surfaces must be porous to the flow of air and a premix air-gas combination.

Air or premix gas-air composition 648, depending upon the operating mode, enters the inlet port 632 and is directed 1120 through the space between the inner furnace wall 618, the burner top head 602, and the outer surfaces of the first 1100 and second 1110 substrate semicones.

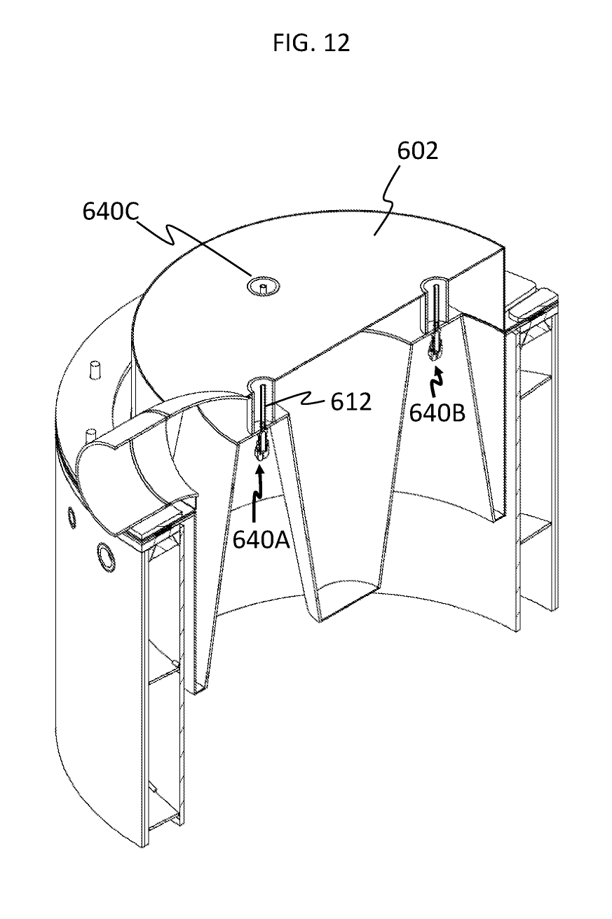

FIG. 12 shows a perspective diagram of an embodiment comprising dual-fuel premix gas and isenthalpic expansion of a preheated, pressurized fuel oil elements and further comprising an inward-firing annular semicone combustion substrate as shown in FIG. 11. When operated as a liquid fuel burner, it is important that ignition be guaranteed throughout the combustion space to ensure a complete and stable combustion process is maintained. Toward this end, multiple oil dispersion nozzles (for example, three shown 640A, 640B and 640C) may be distributed on the burner top head 602 comprising individual oil conduits 612 and nozzle apparatuses 640A.

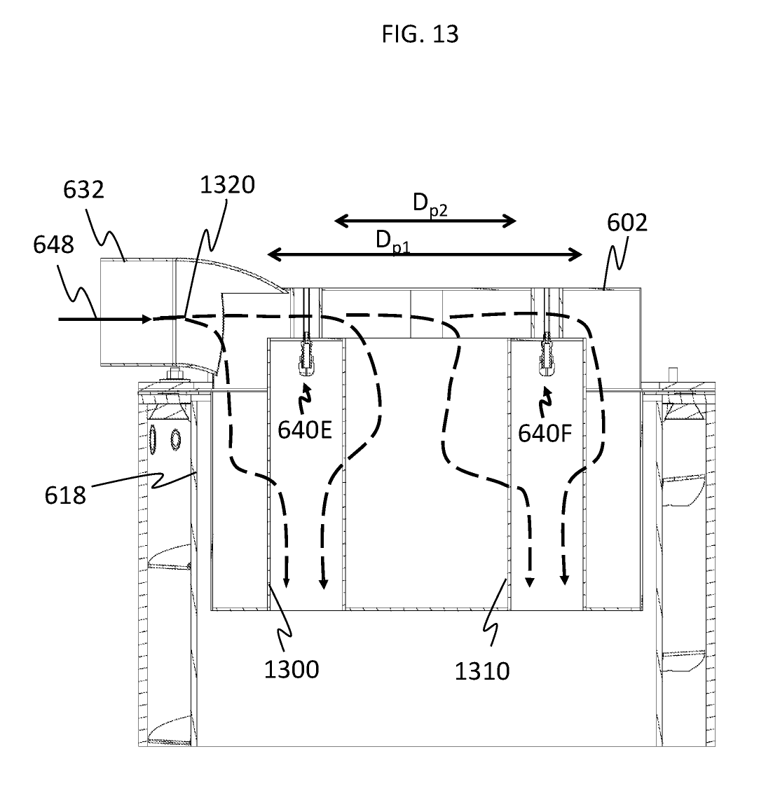

FIG. 13 shows a specialization of the embodiment shown in FIG. 11 and FIG. 12 comprising an annular combustion volume wherein the combustion substrate surfaces comprise concentric annular cylinder substrate sections. FIG. 13 shows a cross-sectional diagram of an embodiment comprising dual-fuel premix gas and isenthalpic expansion of a preheated, pressurized fuel oil elements and further comprising an inward-firing annular cylindrical (semicone with cone angle equal to zero degrees) combustion substrate. The annular semicone substrate comprises two concentric cylindrical surfaces, a first cylindrical substrate surface 1300 with a proximal diameter, Dₚ₁, (the distal and proximal diameters are equal, by definition) and height H₁; and a second cylindrical substrate surface 1310 with a proximal diameter, Dₚ₂, and height H₂. (Proximal to the air inlet; distal from the air inlet.) In this embodiment D_{p2<}Dₚ₁ and H1 and H2 can be any height required by the compactness, performance and burner capacity requirements, otherwise unrelated. One or both of the cylindrical substrate surfaces must be porous to the flow of air and a premix air-gas combination.

Air or premix gas-air composition 648, depending upon the operating mode, enters the inlet port 632 and is directed 1320 through the space between the inner furnace wall 618, the burner top head 602, and the outer surfaces of the first 1300 and second 1310 substrate cylindrical surfaces.

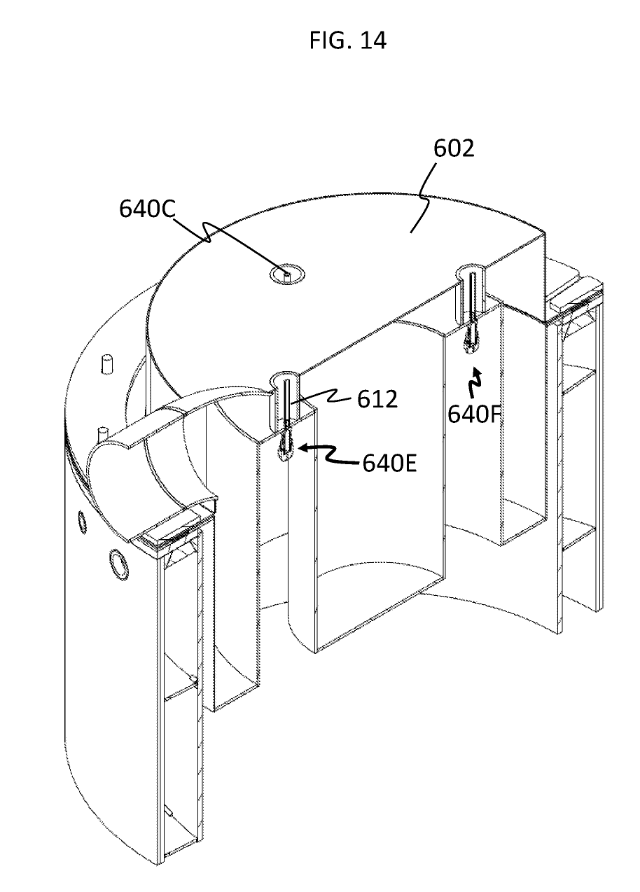

FIG. 14 shows a perspective diagram of an embodiment comprising dual-fuel premix gas and isenthalpic expansion of a preheated, pressurized fuel oil elements and further comprising an inward-firing annular cylindrical combustion substrate as shown in FIG. 13. When operated as a liquid fuel burner, it is important that ignition be guaranteed throughout the combustion space to ensure a complete and stable combustion process is maintained. Toward this end, a plurality of oil dispersion nozzles (for example, three shown 640E, 640F and 640F) may be distributed on the burner top head 602 comprising individual oil conduits 612 and nozzle apparatuses 640A.

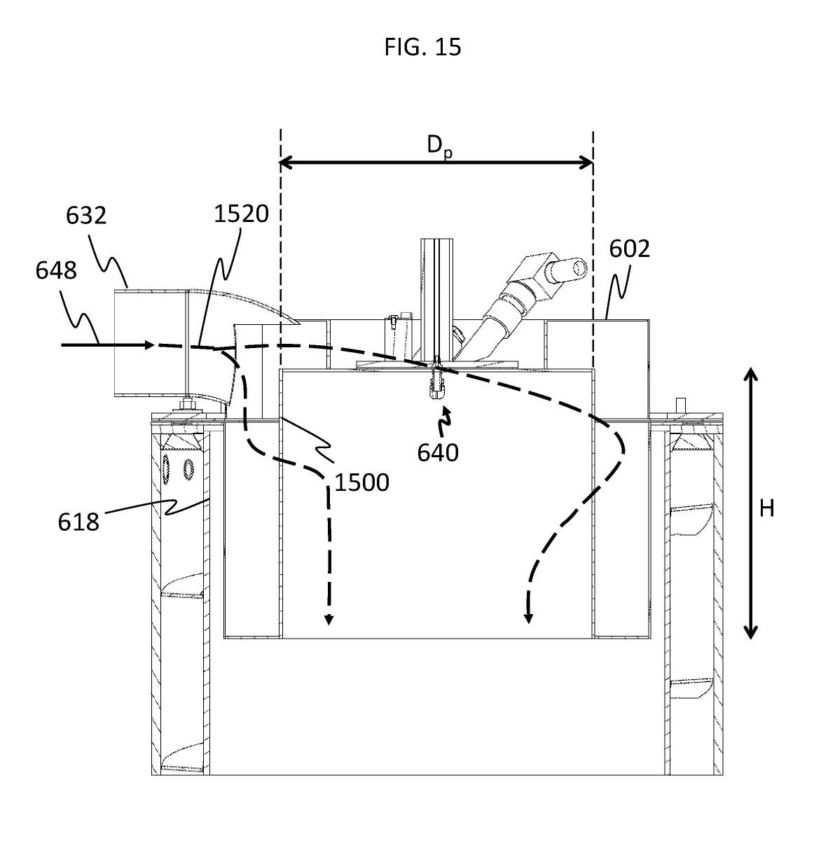

FIG. 15 shows a further specialization of the embodiment shown in FIG. 10A comprising a semicone combustion volume wherein the combustion substrate surface comprises a cylinder substrate section. FIG. 15 shows a cross-sectional diagram of an embodiment comprising dual-fuel premix gas and isenthalpic expansion of a preheated, pressurized fuel oil elements and further comprising an inward-firing cylindrical (semicone with cone angle equal to zero degrees) combustion substrate. The substrate comprises a cylindrical substrate surface 1500 with a proximal diameter, Dₚ, (the distal and proximal diameters are equal, by definition) and height H. (Proximal to the air inlet; distal from the air inlet.) In this embodiment Dₚ and H can be any values required by the compactness, performance and burner capacity requirements, otherwise unrelated. The cylindrical substrate surface must be porous to the flow of air and a premix air-gas combination.

Air or premix gas-air composition 648, depending upon the operating mode, enters the inlet port 632 and is directed 1520 through the space between the inner furnace wall 618, the burner top head 602, and the outer surface of the substrate cylindrical surface 1500.

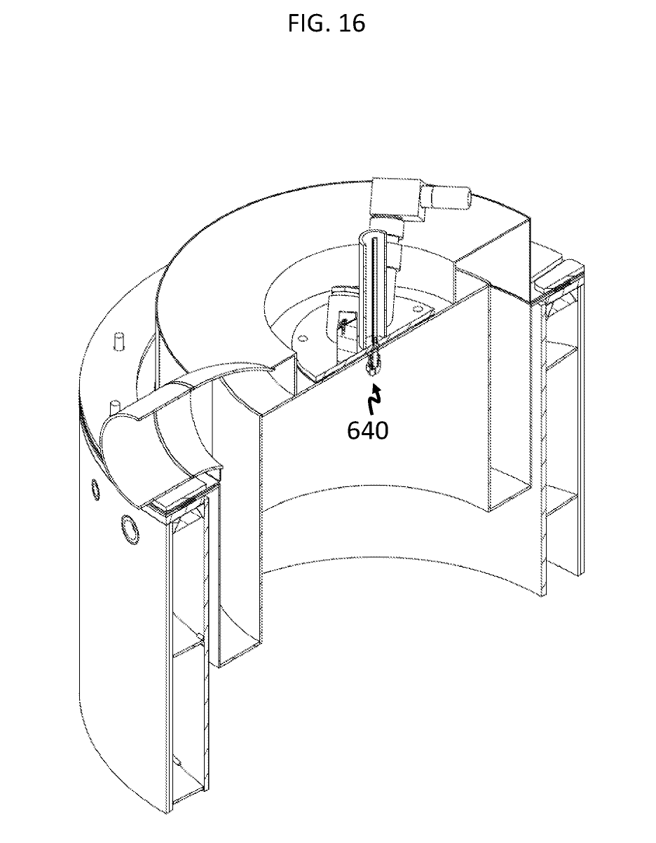

FIG. 16 shows a perspective diagram of an embodiment comprising dual-fuel premix gas and isenthalpic expansion of a preheated, pressurized fuel oil elements and further comprising an inward-firing cylindrical combustion substrate as shown in FIG. 15. When operated as a liquid fuel burner, the single cylindrical combustion volume (equivalently, “cavity”) typically permits the use of a single dispersion nozzle, although for large burner systems, a plurality of burner nozzles may be used.

A tenth feature of the present disclosure is that the geometry of the premix fuel-air combustion substrate that partially forms the boundaries of the combustion cavity, and the geometry of the fuel oil dispersion configuration can be optimized to achieve desirable performance objectives for the system operated in either mode.

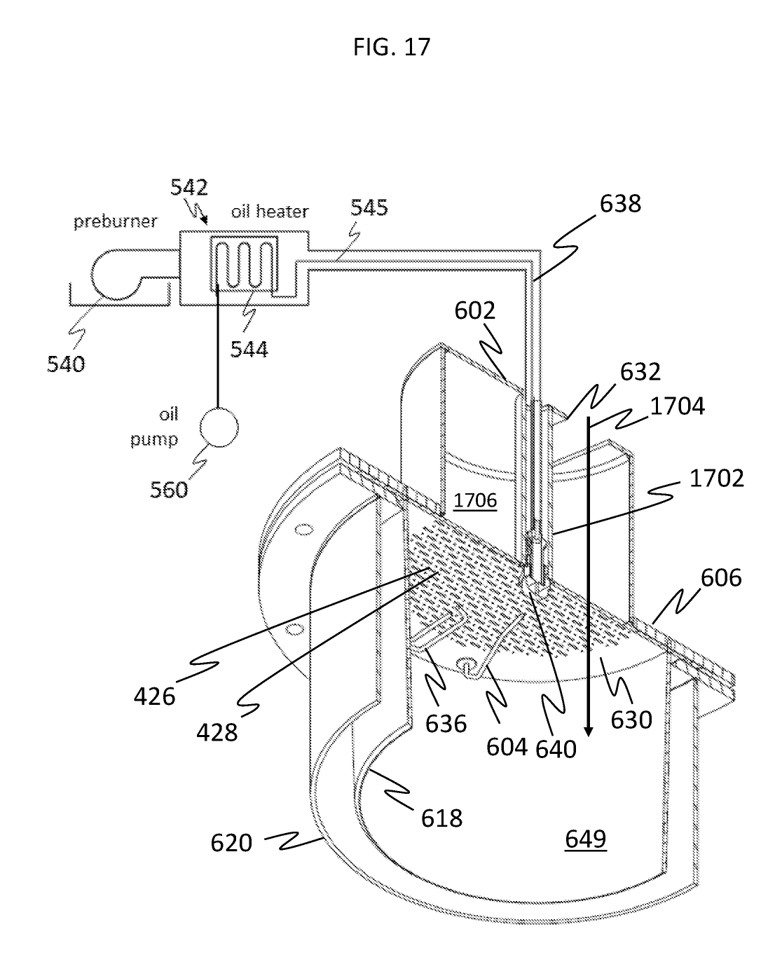

FIG. 17 shows a perspective diagram of an embodiment comprising elements configured for dual-fuel premix gas and isenthalpic expansion of a preheated, pressurized fuel oil. The embodiment shown further comprises a combustion substrate with α=90 degrees (flat plat substrate) that separates the region for premix air-fuel intake 1706 (for premix fuel-air combustion operation) or air intake 1706 (for oil fuel operation) from the combustion region 649 or cavity. For premix gaseous fuel-air operation, in this embodiment the premix fuel air mixture flows 1704 vertically through the inlet 632 into the region 1706 behind the combustion substrate 630, and passes through the combustion substrate pores—shown here as a pattern of distributed slots 426 and holes 428—into the combustion region 649 or cavity. The premix fuel air mixture is ignited by an igniter, such as a spark igniter 636. The combustion field of view may be monitored by a sensor 604. The combustion region or cavity is bounded by the combustion substrate 630 and the inner furnace wall 618 which may be distinct from an outer furnace wall 620. The combustion substrate may be disposed on the furnace top head 606.

When operated as a liquid oil fuel burner, oil contained in a storage location is conveyed by an oil pump 560 to a preheater; for example, a preburner 542 comprising a blower 540 and heat exchanger 544 (oil heater). In an alternative embodiment, the preheater may comprise an electric element. The oil pump 560 and heat exchanger 544 (alternatively, electric element or an equivalent) increase the oil pressure and enthalpy (total heat) by heating the oil (e.g., by a secondary combustion process, or electric heating element). The hot, pressurized oil is conveyed through a conduit 545 to the fluid system through a conduit where it is dispersed by an oil nozzle 640. As the hot oil enters the enlarged combustion volume 640 through the nozzle 640, it experiences an isenthalpic pressure drop, and the oil mixture changes state to a composition of liquid and gas. The oil dispersed by the nozzle 640 is mixed with oxygen (air) forced into the burner by a blower through the inlet 632 and passing from the region 1706 behind the combustion substrate 630, through the substrate pores, shown here as a pattern of slots 426 and holes 428. An igniter 636, which may or may not be the same as for ignition for premix gas operation as it is shown here, is used to combust the oil vapor and the resulting ambient heat released causes combustion of the remaining liquid fraction.

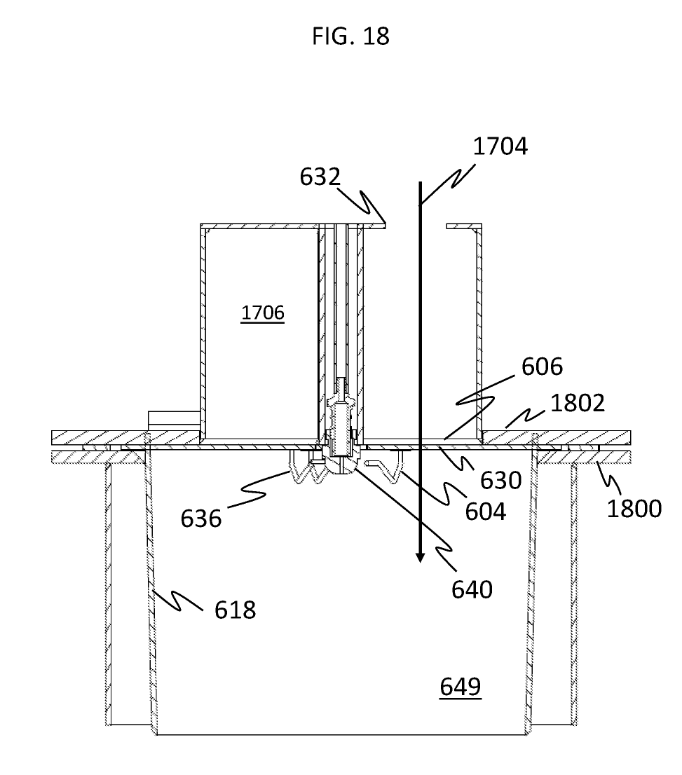

FIG. 18 shows a cross-sectional diagram for the dual fuel combustion systems illustrated in FIG. 17. Premix air-fuel (premix gaseous fuel operation) or air (oil fuel operation) flows through the inlet 632 into the region 1706 behind the combustion substrate 630, through the pores in the combustion substrate 630 and into the combustion cavity 649 bounded by the inner wall for the furnace 618 and the combustion substrate 630. The fuel is ignited by an igniter 636 and the resulting combustion may be monitored by a sensor to ensure proper operation. In an embodiment, the combustion substrate 630 is disposed on the furnace top head 606, held in place between the furnace top head mounting flange 1800 and the burner mounting flange 1802. Other equivalent methods of disposing the combustion substrate to the furnace top head to form part of the combustion cavity are possible are contemplated and are considered within the scope of this disclosure.

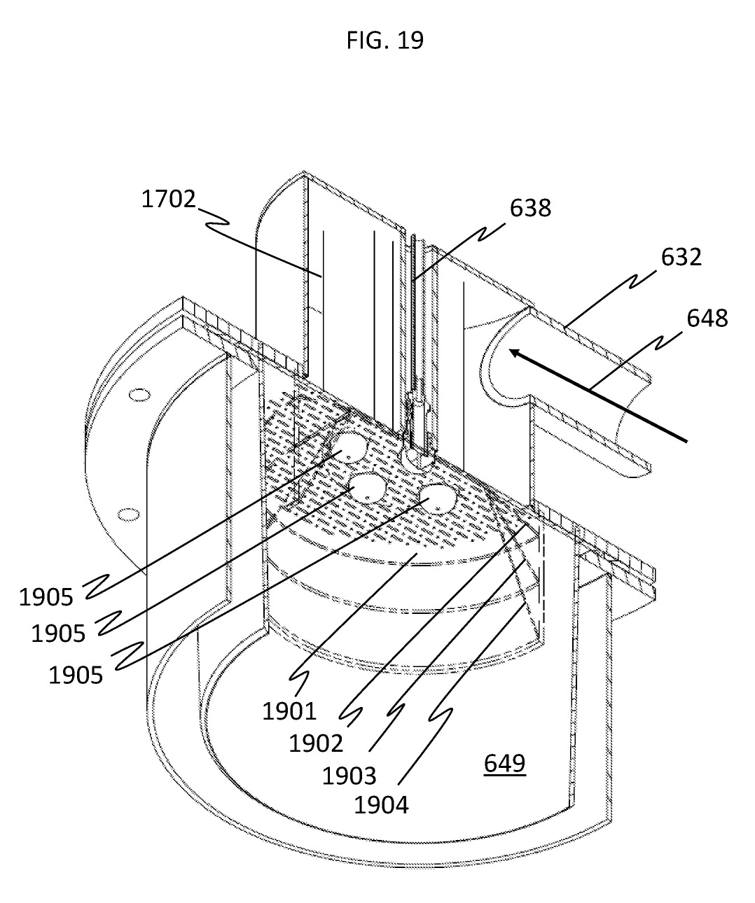

FIG. 19 shows a perspective diagram of an embodiment comprising elements configured for dual-fuel premix gas and isenthalpic expansion of a preheated, pressurized fuel oil. In this embodiment, a plurality of oil nozzles 1905 are used to disperse the preheated and pre-pressured oil into the combustion cavity 649 where it undergoes isenthalpic expansion and ignition. This plurality of oil nozzles may be arranged in any suitable pattern disposed on or near the combustion substrate. This prospective diagram illustrates that the combustion substrate may be any member of a family of semicone geometries, each sharing a common furnace distal diameter, D_{d}. Represented in the diagram is a flat plate (α=90) combustion substrate 1901, together with a sequence of alternative substrate geometries of increasing height (decreasing angle α), from a shallow semicone, a medium semicone 1903 and a steep cone 1904. (Only one combustion substrate is present and used in any particular implementation.) Notice that the combustion substrate surface area increases as the height of the semicone increases within a family, as does the turning angle of the gas flow, both as described in detail above. Each oil nozzle 1905 is fluidically in communication with the source (not shown) of preheated and pre-pressurized oil which is conveyed to each nozzle through an oil conduit 638 which may be protected by a conduit 1702 or sheath.

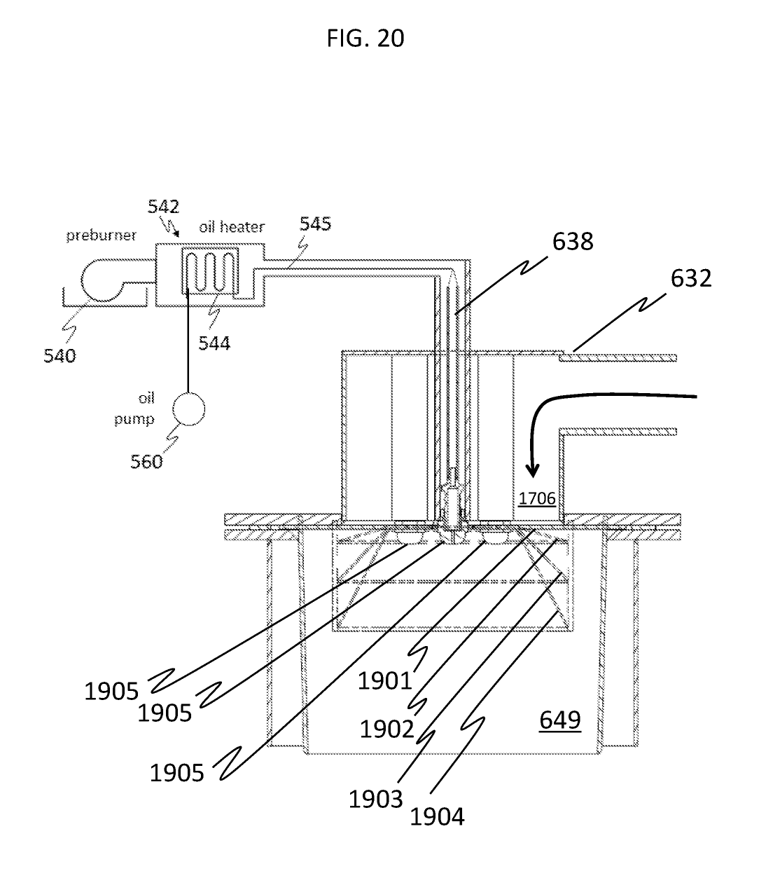

FIG. 20 shows a cross-sectional diagram that further illustrates the oil pathway shown in FIG. 19. When operated as a liquid oil fuel burner, oil contained in a storage location is conveyed by an oil pump 560 to a preheater; for example, a preburner 542 comprising a blower 540 and heat exchanger 544 (oil heater). In an alternative embodiment, the preheater may comprise an electric element. The oil pump 560 and heat exchanger 544 (alternatively, electric element or an equivalent) increase the oil pressure and enthalpy (total heat) by heating the oil (e.g., by a secondary combustion process, or electric heating element). The hot, pressurized oil is conveyed through a conduit 545 to the fluid system through a conduit 638 where it is dispersed by an oil nozzle 1905. As the hot oil enters the enlarged combustion volume 649 through one of the oil nozzles 1905, it experiences an isenthalpic pressure drop, and the oil mixture changes state to a composition of liquid and gas. The oil dispersed by the nozzle 1905 is mixed with oxygen (air) forced into the burner by a blower through the inlet 632 and passing from the region 1706 behind the combustion substrate, through the substrate pores in one of the semicone geometries of flat 1901, shallow 1902, medium 1903 or steep 1904 angles. An igniter is used to combust the oil vapor and the resulting ambient heat released causes combustion of the remaining liquid fraction.

Note that in FIG. 19 and FIG. 20, the premix air-fuel mixture (premix gas-air operation) or air (oil combustion operation), the flow 648 enters the burner through a conduit 632 transverse to the axis of the burner, in contrast to the vertical flow direction shown in the embodiment of FIG. 17 and FIG. 18. The orientation of the flow (vertical, transverse of oblique) may be used by one skilled in the art to promote fuel air mixing, uniform flow into the combustion cavity 649, and achievement of uniform temperature, pressure and combustion properties through the combustion cavity or chamber.

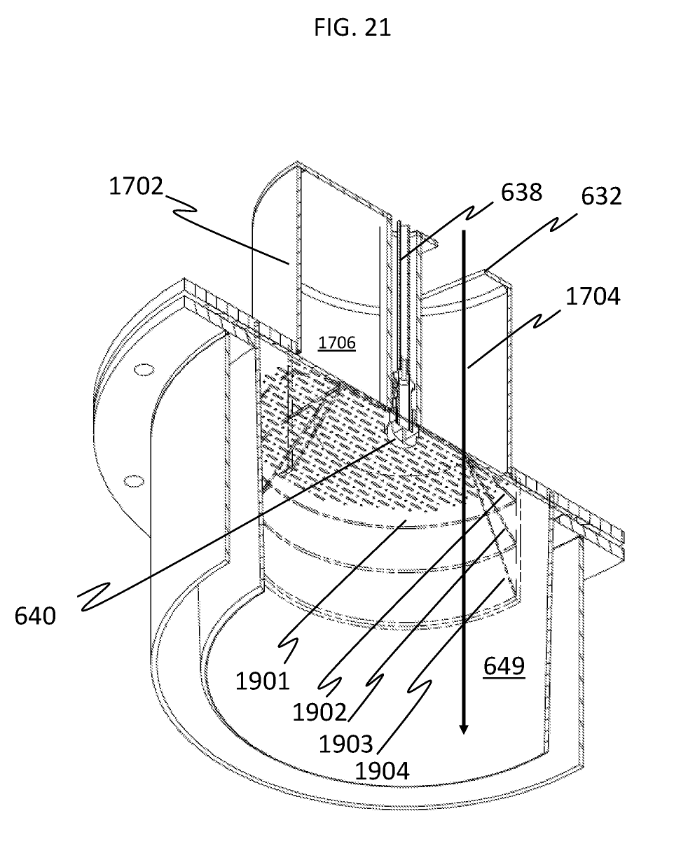

Vertical flow is illustrated in FIG. 21 which shows a perspective diagram of an embodiment comprising elements configured for dual-fuel premix gas and isenthalpic expansion of a preheated, pressurized fuel oil. In this embodiment, a single oil nozzle 640 is used to disperse the preheated and pre-pressured oil into the combustion cavity 649 where it undergoes isenthalpic expansion and ignition. The oil nozzle may be disposed in any suitable location on or near the combustion substrate; the center of the substrate is specifically cited since it will have desirable dispersion properties in a symmetric combustion cavity 649. This prospective diagram illustrates again that the combustion substrate may be any member of a family of semicone geometries, each sharing a common furnace distal diameter, D_{d}. Represented in the diagram is a flat plate (α=90) combustion substrate 1901, together with a sequence of alternative substrate geometries of increasing height (decreasing angle α), from a shallow semicone, a medium semicone 1903 and a steep cone 1904. (Only one combustion substrate is present and used in any particular implementation.) Notice that the combustion substrate surface area increases as the height of the semicone increases within a family, as does the turning angle of the gas flow, both as described in detail above. Each oil nozzle 1905 is fluidically in communication with the source (not shown) of preheated and pre-pressurized oil which is conveyed to each nozzle through an oil conduit 638 which may be protected by a conduit 1702 or sheath. In this embodiment, premix air-fuel mixture (premix gas operation) or air (oil fuel operation) flow 1704 enters an inlet 632 vertically to traverse the region 1706 behind the combustion substrate, through the substrate pores in one of the semicone geometries of flat 1901, shallow 1902, medium 1903 or steep 1904 angles, and pass into the combustion cavity 649.

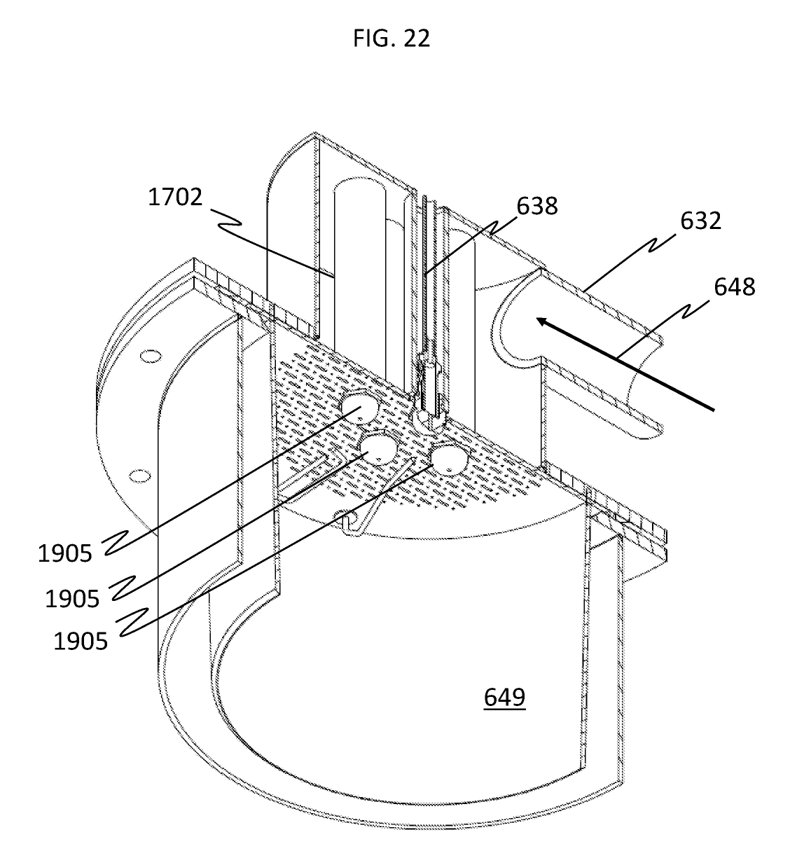

FIG. 22 shows a perspective diagram of an embodiment using transverse flow and an array comprising a plurality of nozzles together with a plate (semicone angle α=90 degrees) combustion substrate. In this embodiment, a plurality of oil nozzles 1905 are used to disperse the preheated and pre-pressured oil into the combustion cavity 649 where it undergoes isenthalpic expansion and ignition. This plurality of oil nozzles may be arranged in any suitable pattern disposed on or near the combustion substrate. This prospective diagram illustrates the limiting case of combustion substrate for a family of semicone geometries with furnace distal diameter, D_{d}, that corresponding to a semicone height of zero (semicone angle α=90 degrees). Each oil nozzle 1905 is fluidically in communication with the source (not shown) of preheated and pre-pressurized oil which is conveyed to each nozzle through an oil conduit 638 which may be protected by a conduit 1702 or sheath.

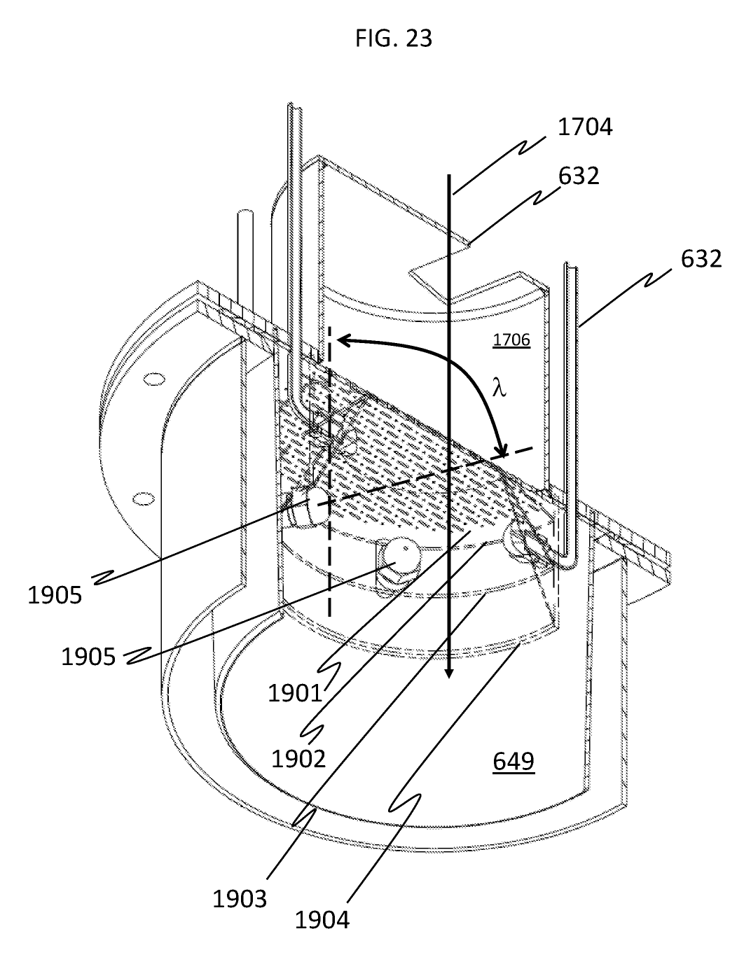

The oil nozzle(s)—whether in a configuration utilizing a single nozzle or a distribution pattern of a plurality of nozzles—may have a dispersion angle parallel to the burner axis (as shown above), or at an angle relative to the burner longitudinal axis. FIG. 23 shows a perspective diagram of an embodiment comprising elements configured for dual-fuel premix gas and isenthalpic expansion of a preheated, pressurized fuel oil. In this embodiment, a plurality of oil nozzles 1905 are used to disperse the preheated and pre-pressured oil into the combustion cavity 649 where it undergoes isenthalpic expansion and ignition. This plurality of oil nozzles may be arranged in any suitable pattern disposed on or near the combustion substrate. In the embodiment shown, the dispersion angle—relative to the longitudinal axis of the combustion burner—is at an angle of λ projected inwards towards the burner centerline. Shown in the FIG. 23 is the case where λ=90 degrees; that is, oil is dispersed perpendicular to the longitudinal axis of the burner and towards the centerline. In this embodiment, the dispersion angles for each nozzle in the array is the same, and the array is distributed uniformly around the circumference of the combustion substrate. However, other arrangements are possible and contemplated, and are considered within the scope of the present disclosure and can be used by those skilled in the art of burner design to achieve desired properties of fuel dispersion, flow, mixing and combustion. Oil entry dispersion angles, λ, between 0 degrees and 180 degrees is specifically mentioned.

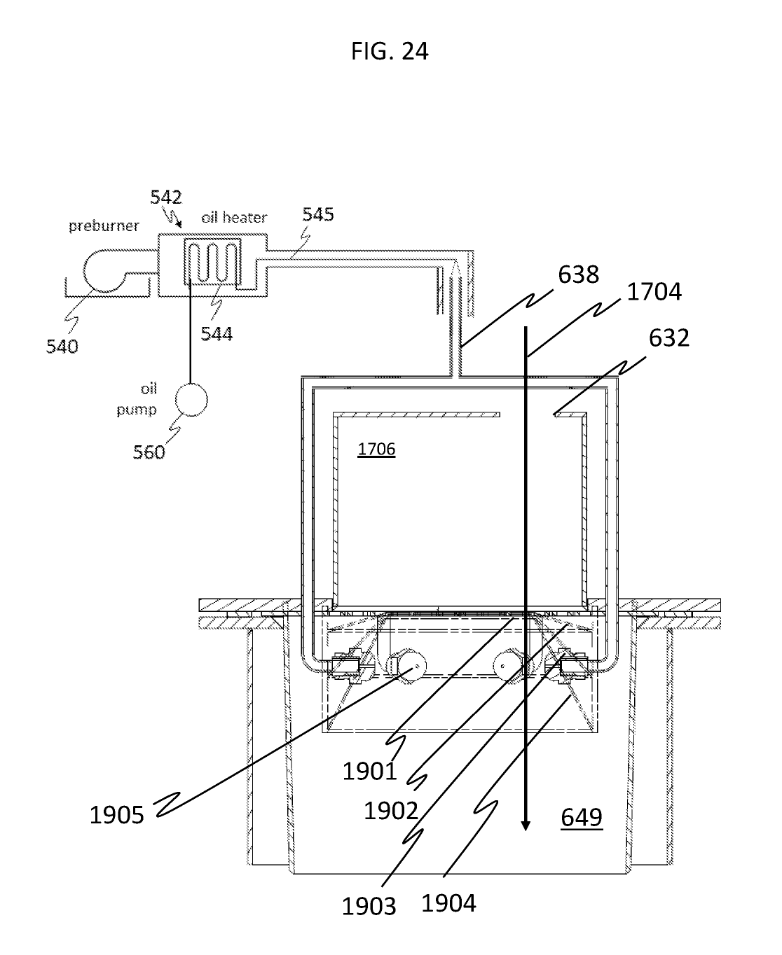

FIG. 24 shows a cross-sectional diagram that further illustrates the oil pathway shown in FIG. 23. When operated as a liquid oil fuel burner, oil contained in a storage location is conveyed by an oil pump 560 to a preheater; for example, a preburner 542 comprising a blower 540 and heat exchanger 544 (oil heater). In an alternative embodiment, the preheater may comprise an electric element. The oil pump 560 and heat exchanger 544 (alternatively, electric element or an equivalent) increase the oil pressure and enthalpy (total heat) by heating the oil (e.g., by a secondary combustion process, or electric heating element). The hot, pressurized oil is conveyed through a conduit 545 to the fluid system through a conduit 638 where it is dispersed by an oil nozzle 1905 within the array of a plurality of nozzles distributed around the circumference of the combustion substrate. As the hot oil enters the enlarged combustion volume 649 through one of the oil nozzles 1905, it experiences an isenthalpic pressure drop, and the oil mixture changes state to a composition of liquid and gas. The oil dispersed by the nozzle 1905 at an entry dispersion angle of λ (here λ=90 degrees) is mixed with oxygen (air) forced into the burner by a blower through the inlet 632 and passing from the region 1706 behind the combustion substrate, through the substrate pores in one of the semicone geometries of flat 1901, shallow 1902, medium 1903 or steep 1904 angles. An igniter is used to combust the oil vapor and the resulting ambient heat released causes combustion of the remaining liquid fraction.

### Embodiments Further Disclosed

### Embodiment A

Further disclosed is a dual fuel burner comprising: a burner casing with an inlet conduit for a premix fuel-air mixture to be disposed in the burner casing; a porous burner combustion substrate disposed in the burner casing wherein: For premix gas-air operation, a premix fuel-air mixture enters the inlet conduit on an outside (exterior) of the burner combustion substrate; a premix fuel-air mixture is disposed under pressure through the burner inlet to an outside of the porous burner combustion substrate; passes through pores in the burner combustion substrate to an interior of the substrate; the fuel-air mixture is ignited in the interior of the burner combustion substrate; combustion gases and products flow from the interior of the burner combustion substrate through an outlet in the burner casing. For liquid fuel operation, a pressurized and preheated liquid fuel is disposed to one or a plurality of dispersion nozzle(s), mixed with air passing through the substrate and ignited or autoignited.

### Embodiment B

Further disclosed is the dual fuel burner of Embodiment A, wherein the porous burner combustion substrate has the shape of a cylinder.

### Embodiment C

Further disclosed is the dual fuel burner of Embodiment A, wherein the porous burner combustion substrate has the shape of a composite semi-cone.

### Embodiment D

Further disclosed is the dual fuel burner of Embodiment A, wherein the porous burner combustion substrate has the shape of a semi-cone.

### Embodiment E

Further disclosed is the dual fuel burner of Embodiment A, wherein the porous burner combustion substrate has the shape of a truncated cone.

### Embodiment F

Further disclosed is the dual fuel burner of Embodiment A, wherein the porous burner combustion substrate has the shape of a circular truncated cone.

### Embodiment G

Further disclosed is the dual fuel burner of Embodiment A, wherein the porous burner combustion substrate has the shape of a right circular truncated cone.

### Embodiment H

Further disclosed is the dual fuel burner of Embodiment A, wherein the porous burner combustion substrate has the shape of a frustum.

### Embodiment I

Further disclosed is the dual fuel burner of Embodiment A, wherein the porous burner combustion substrate has the shape of a circular frustum.

### Embodiment J

Further disclosed is the dual fuel burner of Embodiment A, wherein the porous burner combustion substrate has the shape of a right circular frustum.

### Embodiment K

Further disclosed is the dual fuel burner of Embodiment A, wherein the porous burner combustion substrate has the shape of a semicone with zero height; equivalently, semicone angel equal to 90 degrees; equivalently, a plate, surface, disk, annulus.

### Embodiment L

Further disclosed is the dual fuel burner of any of Embodiments A to L, further comprising a plurality of burner casing inlets disposed on the burner casing.

### Embodiment M

Further disclosed is the dual fuel burner of any of Embodiments A to L, further comprising a plurality of oil dispersion nozzles.

### Embodiment N

Further disclosed is the dual fuel burner of any of Embodiments A to M, further comprising one or a plurality of oil dispersion nozzles with dispersion oriented at a vertical angle between zero and 180 degrees relative to the combustion burner centerline.

### Embodiment O

Further disclosed is the dual fuel burner of any of Embodiments A to N, further comprising one or a plurality of oil dispersion nozzles with dispersion oriented rotated at a horizontal angle between zero and 360 degrees relative to the combustion burner centerline.

Further disclosed is a hydronic fluid heating system (equivalently, a “hydronic boiler”) comprising a dual fuel combustion system of any of Embodiments A to O or elsewhere disclosed in this specification.

Further disclosed is a steam fluid heating system (equivalently, a “steam boiler”) comprising a dual fuel combustion system of any of Embodiments A to K or elsewhere disclosed in this specification.

Further disclosed is a thermal fluid heating system (equivalently, a “thermal fluid boiler”) comprising a dual fuel combustion system of any of Embodiments A to K or elsewhere disclosed in this specification.

Further disclosed is a packaged burner comprising a dual fuel combustion system of any of Embodiments A to K or elsewhere disclosed in this specification.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

What is claimed is:

1. An inward-firing dual fuel combustion burner, comprising:
a burner casing configured to receive a gaseous mixture at a burner inlet and to provide hot combustion gas at a burner output;
a combustion substrate disposed within the burner casing, the substrate having a shape comprising at least a semi-cone, having a substrate angle measured from a longitudinal axis, having a substrate porosity defined by a plurality of pores, and having a substrate inner surface and a substrate outer surface;
the substrate configured to receive either air or the fuel-air mixture at the outer surface of the substrate, the air or fuel-air mixture passing through the pores at a flow rate from the substrate outer surface toward the substrate inner surface;
one or a plurality of oil nozzles disposed within the combustion cavity defined by the substrate in fluidic communication with a source of pre-heated and pre-pressurized oil fuel, an oil nozzle configured to receive the oil fuel and disperse the oil fuel into the cavity;
the burner configured to be operated using either a gaseous premix fuel air mixture or a pre-heated and pre-pressurized liquid fuel oil;
the burner configured such that, during gaseous premix fuel operation, the fuel-air mixture is provided through the pores into the combustion cavity, the fuel-air mixture ignites near the plurality of pores to form a respective plurality of flamelets, each flamelet corresponding to one of the pores; and
the burner configured such that, during oil fuel operation, the pre-heated and pre-pressurized oil fuel is provided to the oil nozzles and the air is provided through the pores into the combustion cavity such that the oil and gas mixture in the combustion cavity ignites during isenthalpic expansion.

2. The burner of claim 1, wherein during gaseous premix fuel operation the plurality of flamelets exhibits suspended flame combustion (SF).

3. The burner of claim 1, wherein the substrate angle has a range of values from 1 degree to 90 degrees (flat).

4. The burner of claim 1 wherein during gaseous premix fuel operation the porosity is set such that a flame equilibrium ratio balances the force due to the premix fuel flow through the pore and the opposing force due to the reaction zone for 1<ρ<100.

5. The burner of claim 1 wherein during gaseous premix fuel operation a volume of the burner casing, a proximal diameter (Dₚ) of the substrate, a distal diameter (D_{d}) of the substrate, and a semi-cone angle of the substrate, are set such that the mixture rate is substantially uniform along a length of the substrate and the plurality of flamelets forms a substantially uniform flame front along the inner surface of the substrate.

6. The burner of claim 1, wherein during gaseous premix fuel operation each flamelet is disposed a flamelet separation distance from the substrate inner surface, the separation distance being determined by at least one of the substrate porosity and the mixture rate such that each flamelet does not move through its corresponding pore to the substrate outer surface, and such that each flamelet remains ignited while the fuel-air mixture is flowing.

7. The burner of claim 6 wherein during gaseous premix fuel operation the flamelet separation distance is related to at least one of: the substrate porosity, the mixture rate, and substrate angle.

8. The burner of claim 1, wherein during gaseous premix fuel operation the plurality of flamelets provides a substantially uniform temperature distribution across the substrate inner surface and provides a substantially uniform flow field distribution of the hot combustion gas at the burner output.

9. The burner of claim 1, wherein during gaseous premix fuel operation the substrate comprises a plurality of porous layers to create the substrate porosity.

10. The burner of claim 1, wherein the shape of the substrate comprises at least one of: cone, semi-cone, composite semi-cone, truncated cone, frustum, right frustum, right circular truncated cone, right circular frustum, and a flat structure.

11. The burner of claim 1, wherein the pores have a shape comprising at least one of: circular, rectangular, symmetrical shape, and asymmetrical shape.

12. Burner of claim 11, wherein the shape of at least one pore is an approximately circular of maximum diameter between 0.5 millimeters and 2 millimeters.

13. Burner of claim 11, wherein the shape of at least one pore is approximately a slot with width between 0.5 millimeters and 2 millimeters and length between 2 millimeters and 15 millimeters.

14. The burner of claim 1, further comprising a baffle, disposed between the substrate and the burner casing, and arranged to receive the fuel-air mixture.

15. The burner of claim 1, further comprising an igniter disposed on an inner side of the substrate where combustion occurs.

16. The burner of claim 1, wherein the combustion substrate comprises a proximal diameter (Dₚ) about 1 to 59 inches, a distal diameter (D_{d}) between 1 and 60 inches, a substrate height (H) between 1 and 60 inches, and a substrate angle between 1 degree and 90 degrees (flat).

17. The burner of claim 1 wherein the oil is pre-heated to a temperature of about 350 degrees to 900 degrees Fahrenheit and the oil is pre-pressurized to a pressure of about 200 PSI to 500 PSI.

18. The burner of claim 1 wherein at least one of the oil nozzles have a dispersion angle which is set such that a flame length in the combustion cavity is between incomplete combustion and spray impingement.

19. The burner of claim 1 wherein the substrate angle comprises a cone angle which is set to provide a predetermined streamline maximum vertical deviation.

20. The burner of claim 1 wherein at least one of the oil nozzles is disposed on at least one of: radially around the combustion cavity pointing inward toward a central axis of the cavity and near a burner top head pointing into the combustion cavity along a central axis of the cavity.

21. A method of burning two different fuels in a combustion burner during different operation times, comprising:
providing a burner that can accept either a gaseous premix fuel-air mixture during gaseous premix fuel operation or a pre-heated and pre-pressurized liquid fuel oil during oil fuel operation, the burner having a porous substrate with an inner surface and an outer surface, the outer surface facing a combustion chamber, and having one or more oil nozzles disposed within the combustion cavity;
during gaseous premix fuel operation, receiving the fuel-air mixture at the outer surface of the substrate, the fuel-air mixture passing through pores in the substrate from the substrate outer surface toward an opposite substrate inner surface, and igniting the fuel-air mixture near the pores to form flamelets, each flamelet corresponding to one of the pores; and
during oil fuel operation, receiving, the pre-heated and pre-pressurized oil fuel at the one or more oil nozzles, dispersing, by the oil nozzles, the oil fuel into the combustion cavity such that the oil converts from a liquid oil state to a gaseous oil state through isenthalpic expansion in the combustion cavity, mixing the gaseous oil with air provided through the pores into the combustion cavity to create a gaseous oil-air mixture, and igniting the gaseous oil-air mixture in the combustion cavity

22. An inward-firing dual fuel combustion burner, comprising:
a porous substrate having an inner surface and an opposite outer surface, the outer surface facing a combustion chamber, and having one or more oil nozzles disposed within the combustion cavity;
the substrate configured to receive either air or a fuel-air mixture at the outer surface of the substrate, the air or fuel-air mixture passing through the porous substrate at a flow rate from the substrate outer surface toward the substrate inner surface;
at least one oil nozzle disposed within the combustion cavity configured to receive pre-heated and pre-pressurized oil fuel and to disperse the oil fuel into the cavity;
the burner configured to be operated using either a gaseous premix fuel air mixture during gaseous premix fuel operation or a pre-heated and pre-pressurized liquid fuel oil during oil fuel operation;
the burner configured such that, during gaseous premix fuel operation, the fuel-air mixture is provided through the porous substrate into the combustion cavity and the fuel-air mixture ignites near pores in the porous substrate to form a respective plurality of flamelets in the combustion cavity, each flamelet corresponding to one of the pores; and
the burner configured such that, during oil fuel operation, the pre-heated and pre-pressurized oil fuel is provided to the nozzles and the air is provided through the porous substrate into the combustion cavity such that the oil and air mixture in the combustion cavity ignites during isenthalpic expansion.
